(19) United States
(12) Patent Application Publication
(10) Pub. No.: US 2020/0175502 A1
(43) Pub. Date: Jun. 4, 2020

(54) CONFIDENTIAL TRANSACTION IN A BLOCKCHAIN NETWORK

(71) Applicant: Alibaba Group Holding Limited, George Town (KY)

(72) Inventors: Huanyu Ma, Hangzhou (CN); Baoli Ma, Hangzhou (CN)

(73) Assignee: Alibaba Group Holding Limited, George Town (KY)

(21) Appl. No.: 16/779,499

(22) Filed: Jan. 31, 2020

Related U.S. Application Data
(63) Continuation of application No. PCT/CN2020/071474, filed on Jan. 10, 2020.

(30) Foreign Application Priority Data
Jul. 31, 2019 (CN) 201910704690.1

(51) Int. Cl. G06Q 20/36; G06Q 20/08; G06Q 20/38; G06F 16/23; G06Q 20/10; G06Q 20/40; G06Q 20/06

(52) U.S. Cl. CPC G06Q 20/3676; G06Q 20/085; G06Q 20/3825; G06Q 20/3672; G06Q 2220/00; G06Q 20/389; G06Q 20/105; G06Q 20/4037; G06Q 20/0655; G06F 16/2365

(57) ABSTRACT

One or more implementations of the present specification provide a method and an apparatus for implementing a confidential transaction in a blockchain network. The method can include: determining a remittance amount between a remitter and a remittee; creating a remittance transaction based on a selected asset amount commitment in the remitter account and a specified number corresponding to each selected asset amount commitment; and submitting the remittance transaction to the blockchain network, thereby causing the blockchain network, or programs monitoring the blockchain network, to perform operations comprising: subtracting the corresponding specified number from a total number corresponding to each selected asset amount commitment, increasing the revenue balance of the remitter account by a change amount commitment after the transaction is completed, and increasing a revenue balance of a remittee account corresponding to the remittee in the blockchain ledger by the remittance amount commitment after the transaction is completed.

### CROSS-REFERENCE TO RELATED APPLICATIONS

This application is a continuation of PCT Application No. PCT/CN2020/071474, filed on Jan. 10, 2020, which claims priority to Chinese Patent Application No. 201910704690.1, filed on Jul. 31, 2019, and each application is hereby incorporated by reference in its entirety.

### TECHNICAL FIELD

One or more implementations of the present specification relate to the field of blockchain technologies, and in particular, to a method and an apparatus for implementing a confidential transaction in a blockchain network.

### BACKGROUND

Distributed ledger systems (DLSs), which can also be referred to as consensus networks, and/or blockchain networks, enable participating entities to securely, and immutably store data. DLSs are commonly referred to as blockchain networks without referencing any particular user case. Examples of types of blockchain networks can include public blockchain networks, private blockchain networks, and consortium blockchain networks. A consortium blockchain network is provided for a select group of entities, which control the consensus process, and includes an access control layer.

### SUMMARY

One or more implementations of the present specification provide a method and an apparatus for implementing a confidential transaction in a blockchain network.

One or more implementations of the present specification provide the following technical solutions:

According to a first aspect of one or more implementations of the present specification, a method for implementing a confidential transaction in a blockchain network is proposed, and the method is applied to a remitter device. The method includes: determining a remittance amount between a remitter and a remittee, where the remitter has a corresponding remitter account in a blockchain ledger, the remitter account includes a revenue balance recorded as a revenue balance commitment, an asset whose corresponding asset amount is recorded as an asset amount commitment, and a total number of an asset amount commitment with each value, and assets having the same asset amount have the same asset amount commitment; creating a remittance transaction based on a selected asset amount commitment in the remitter account and a specified number corresponding to each selected asset amount commitment, where the remittance transaction includes a remittance amount commitment corresponding to the remittance amount, each selected asset amount commitment and a corresponding specified number, and a range proof (RP) used to prove that the remittance amount is non-negative and not greater than a total asset amount, and the total asset amount is a weighted sum of an asset amount corresponding to each selected asset amount commitment and the corresponding specified number; and submitting the remittance transaction to a blockchain, so the corresponding specified number is subtracted from a total number corresponding to each selected asset amount commitment, the revenue balance of the remitter account is increased by a change amount commitment after the transaction is completed, and a revenue balance of a remittee account corresponding to the remittee in the blockchain ledger is increased by the remittance amount commitment after the transaction is completed.

According to a second aspect of one or more implementations of the present specification, a method for implementing a confidential transaction in a blockchain network is proposed, and the method is applied to a blockchain node. The method includes: receiving a remittance transaction, where the remittance transaction includes a remittance amount commitment corresponding to a remittance amount between a remitter and a remittee, at least one asset amount commitment and a corresponding specified number, and an RP used to prove that the remittance amount is non-negative and not greater than a total asset amount, where the total asset amount is a weighted sum of an asset amount corresponding to the at least one asset amount commitment and the corresponding specified number, and a remitter account corresponding to the remitter in a blockchain ledger includes a revenue balance recorded as a revenue balance commitment, an asset whose corresponding asset amount is recorded as an asset amount commitment, and a total number of an asset amount commitment with each value, and assets having the same asset amount have the same asset amount commitment; and executing the remittance transaction, so a corresponding specified number is subtracted from a total number corresponding to each asset amount commitment included in the remittance transaction, the revenue balance of the remitter account is increased by a change amount commitment after the transaction is completed, and a revenue balance of a remittee account corresponding to the remittee in the blockchain ledger is increased by the remittance amount commitment after the transaction is completed.

According to a third aspect of one or more implementations of the present specification, an apparatus for implementing a confidential transaction in a blockchain network is proposed, and the apparatus is applied to a remitter device. The apparatus includes: a determining unit, configured to determine a remittance amount between a remitter and a remittee, where the remitter has a corresponding remitter account in a blockchain ledger, the remitter account includes a revenue balance recorded as a revenue balance commitment, an asset whose corresponding asset amount is recorded as an asset amount commitment, and a total number of an asset amount commitment with each value, and assets having the same asset amount have the same asset amount commitment; a creation unit, configured to create a remittance transaction based on a selected asset amount commitment in the remitter account and a specified number corresponding to each selected asset amount commitment, where the remittance transaction includes a remittance amount commitment corresponding to the remittance amount, each selected asset amount commitment and a corresponding specified number, and an RP used to prove that the remittance amount is non-negative and not greater than a total asset amount, and the total asset amount is a weighted sum of an asset amount corresponding to each selected asset amount commitment and the corresponding specified number; and a submission unit, configured to submit the remittance transaction to a blockchain, so the corresponding specified number is subtracted from a total number corresponding to each selected asset amount commitment, the revenue balance of the remitter account is increased by a change amount commitment after the transaction is completed, and a revenue balance of a remittee account corresponding to the remittee in the blockchain ledger is increased by the remittance amount commitment after the transaction is completed.

According to a fourth aspect of one or more implementations of the present specification, an apparatus for implementing a confidential transaction in a blockchain network is proposed, and the apparatus is applied to a blockchain node. The apparatus includes: a receiving unit, configured to receive a remittance transaction, where the remittance transaction includes a remittance amount commitment corresponding to a remittance amount between a remitter and a remittee, at least one asset amount commitment and a corresponding specified number, and an RP used to prove that the remittance amount is non-negative and not greater than a total asset amount, where the total asset amount is a weighted sum of an asset amount corresponding to the at least one asset amount commitment and the corresponding specified number, and a remitter account corresponding to the remitter in a blockchain ledger includes a revenue balance recorded as a revenue balance commitment, an asset whose corresponding asset amount is recorded as an asset amount commitment, and a total number of an asset amount commitment with each value, and assets having the same asset amount have the same asset amount commitment; and an execution unit, configured to execute the remittance transaction, so a corresponding specified number is subtracted from a total number corresponding to each asset amount commitment included in the remittance transaction, the revenue balance of the remitter account is increased by a change amount commitment after the transaction is completed, and a revenue balance of a remittee account corresponding to the remittee in the blockchain ledger is increased by the remittance amount commitment after the transaction is completed.

According to a fifth aspect of one or more implementations of the present specification, an electronic device is proposed, including: a processor; and a memory, configured to store instructions that can be executed by the processor; where the processor implements the method according to the first aspect by running the executable instructions.

According to a sixth aspect of one or more implementations of the present specification, a computer readable storage medium is provided, where computer instructions are stored on the computer readable storage medium, and the instructions are executed by a processor to implement the steps of the method according to the first aspect.

According to a seventh aspect of one or more implementations of the present specification, an electronic device is proposed, including: a processor; and a memory, configured to store instructions that can be executed by the processor; where the processor implements the method according to the second aspect by running the executable instructions.

According to an eighth aspect of one or more implementations of the present specification, a computer readable storage medium is provided, where computer instructions are stored on the computer readable storage medium, and the instructions are executed by a processor to implement the steps of the method according to the second aspect.

### BRIEF DESCRIPTION OF DRAWINGS

FIG. 1 is a schematic diagram illustrating an example environment, according to an exemplary implementation;

FIG. 2 is a schematic diagram illustrating a conceptual architecture, according to an exemplary implementation;

FIG. 3 is a flowchart illustrating a method for implementing a confidential transaction in a blockchain network, according to an exemplary implementation;

FIG. 4 is a schematic diagram illustrating a blockchain ledger structure, according to an exemplary implementation;

FIG. 5 is a flowchart illustrating a privacy-protected remittance transaction, according to an exemplary implementation;

FIG. 6 is a schematic diagram illustrating account changes before and after a remittance, according to an exemplary implementation;

FIG. 7 is a schematic diagram illustrating another blockchain ledger structure, according to an exemplary implementation;

FIG. 8 is a schematic interaction diagram illustrating asset recharging by using a primary balance, according to an example implementation;

FIG. 9 is a schematic diagram illustrating account changes before and after recharging, according to an exemplary implementation;

FIG. 10 is a schematic interaction diagram illustrating a merging operation, according to an example implementation;

FIG. 11 is a schematic diagram illustrating account changes before and after merging, according to an exemplary implementation;

FIG. 12 is a flowchart illustrating a primary balance transfer transaction, according to an exemplary implementation;

FIG. 13 is a schematic diagram illustrating account changes before and after a primary balance remittance, according to an exemplary implementation;

FIG. 14 is a flowchart illustrating a method for implementing a confidential transaction in another blockchain network, according to an exemplary implementation;

FIG. 15 is a schematic structural diagram illustrating a device, according to an example implementation;

FIG. 16 is a block diagram illustrating an apparatus for implementing a confidential transaction in a blockchain network, according to an exemplary implementation;

FIG. 17 is a schematic structural diagram illustrating another device, according to an example implementation;

FIG. 18 is a block diagram illustrating an apparatus for implementing a confidential transaction in another blockchain network, according to an exemplary implementation.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Example implementations described in the following do not represent all implementations consistent with the present specification. On the contrary, the implementations are only examples of apparatus and methods that are described in the appended claims in detail and consistent with some aspects of the present specification.

It is worthwhile to note that, in other implementations, steps of a corresponding method are not necessarily performed according to a sequence shown and described in the present specification. In some other implementations, the method can include more or less steps than those described in the present specification. In addition, a single step described in the present specification can be broken down into multiple steps in other implementations for description. However, the multiple steps described in the present specification can also be combined into a single step for description in other implementations.

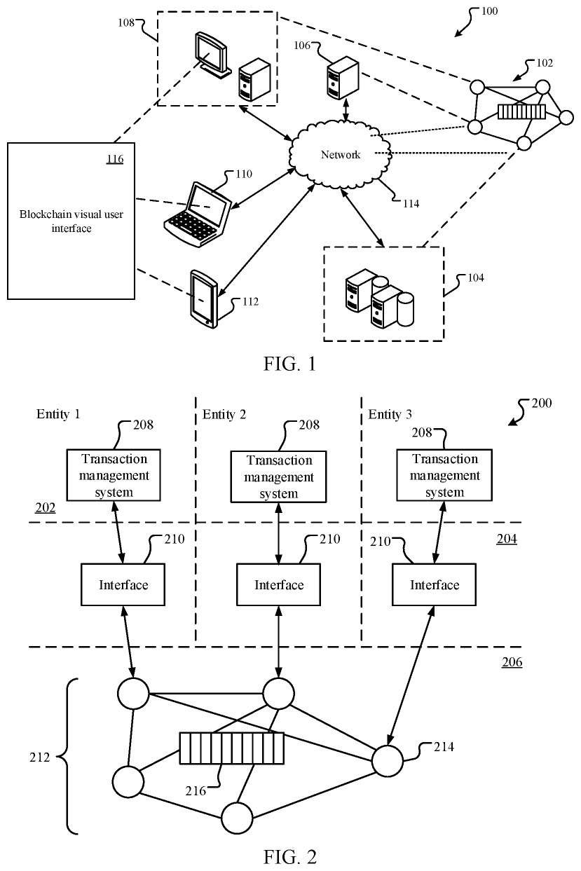

FIG. 1 is a schematic diagram illustrating an example environment, according to an exemplary implementation. As shown in FIG. 1, an example environment 100 allows entities to participate in a blockchain network 102. The blockchain network 102 can be of a public type, a private type, or a consortium type. The example environment 100 can include computing devices 104, 106, 108, 110, and 112 and a network 114. In an implementation, the network 114 can include a local area network (LAN), a wide area network (WAN), the Internet, or a combination thereof, and be connected to a website, user equipment (e.g., a computing device), and a backend system. In an implementation, the network 114 can be accessed wired and/or wirelessly.

In some cases, the computing devices 106 and 108 can be nodes (not shown) of a cloud computing system, or each of the computing devices 106 and 108 can be a separate cloud computing system, including multiple computers interconnected by a network and operating as a distributed processing system.

In an implementation, the computing devices 104 to 108 can run any suitable computing system to enable the computing devices to function as nodes in the blockchain network 102. For example, the computing devices 104 to 108 can include but are not limited to servers, desktop computers, notebook computers, tablet computers, computing devices, and smartphones. In an implementation, the computing devices 104 to 108 can belong to related entities and be configured to implement corresponding services. For example, the service can be used to manage transactions of one entity or among multiple entities.

In an implementation, the computing devices 104 to 108 separately store blockchain ledgers corresponding to the blockchain network 102. The computing device 104 can be (or include) a network server configured to provide a browser function, and the network server can provide visualization information related to the blockchain network 102 based on the network 114. In some cases, the computing device 104 does not participate in block verification, but monitor the blockchain network 102 to determine when other nodes (such as the computing devices 106 to 108) reach a consensus, and thereby generate a corresponding blockchain visual user interface.

In an implementation, the computing device 104 can receive a request from a client device (such as the computing device 110 or the computing device 112) for a blockchain visual user interface. In some cases, a node of the blockchain network 102 can also be used as a client device, for example, a user of the computing device 108 can send the previous request to the computing device 104 by using a browser running on the computing device 108.

In response to the previous request, the computing device 104 can generate a blockchain visual user interface (such as a web page) based on the stored blockchain ledger, and send the generated blockchain visual user interface to the requested client device. If the blockchain network 102 is of a private type or a consortium type, the request for the blockchain visual user interface can include user authorization information. Before the blockchain visual user interface is generated and sent to the requested client device, the computing device 104 can verify the user authorization information, and after the verification succeeds, return the corresponding blockchain visual user interface.

The blockchain visual user interface can be displayed on the client device (for example, can be displayed on the user interface 116 shown in FIG. 1). When the blockchain ledger is updated, display content of the user interface 116 can also be updated accordingly. In addition, interaction between a user and the user interface 116 can result in a request for another user interface, such as displaying a block list, block details, a transaction list, transaction details, an account list, account details, a contract list, contract details, or a search result page generated by the user by searching in the blockchain network.

FIG. 2 is a schematic diagram illustrating a conceptual architecture, according to an exemplary implementation. As shown in FIG. 2, the conceptual architecture 200 includes an entity layer 202, a hosting service layer 204, and a blockchain network layer 206. For example, the entity layer 202 can include three entities: entity 1, entity 2, and entity 3, each having its own transaction management system 208.

In an implementation, the hosting service layer 204 can include an interface 210 corresponding to each transaction management system 208. For example, each transaction management system 208 communicates with a respective interface 210 over a network (e.g., the network 114 in FIG. 1) using a protocol (e.g., Hypertext Transfer Protocol Secure (HTTPS)). In some examples, each interface 210 can provide a communicative connection between a respective transaction management system 208 and the blockchain network layer 206. More specifically, the interface 210 can communicate with the blockchain network 212 of the blockchain network layer 206. In some examples, communication between the interface 210 and the blockchain network layer 206 can be implemented by using remote procedure calls (RPC). In some examples, the interface 210 can provide an API interface for accessing the blockchain network 212 to the transaction management system 208.

As described here, the blockchain network 212 is provided in the form of a peer-to-peer network including a plurality of nodes 214 that are respectively configured to persist blockchain ledgers 216 formed from blockchain data. FIG. 2 shows only one blockchain ledger 216, but multiple blockchain ledgers 216 or copies can exist in the blockchain network 212. For example, each node 214 can separately maintain one blockchain ledger 216 or copy.

A blockchain is generally classified into three types: a public blockchain, a private blockchain, and a consortium blockchain. In addition, there are several types of combinations, such as private blockchain+consortium blockchain and consortium blockchain+public blockchain. The public blockchain has the highest degree of de-centralization. The public blockchain is represented by Bitcoin and Ethereum. Participants who join the public blockchain can read on-chain data records, participate in transactions, and compete for accounting rights of new blocks. Furthermore, each participant (i.e., node) can freely join and exit the network and perform related operations. On the contrary, a write right of the private blockchain network is controlled by a certain organization or institution, and a data reading right is specified by the organization. In short, the private blockchain can be a weak centralization system, and participating nodes are fewer and more restricted. This type of blockchain is more suitable for internal use within a specific organization. The consortium blockchain is a blockchain balanced between the public blockchain and the private blockchain, and can be “partially decentralized”. Each node in the consortium blockchain usually has a corresponding entity institution or organization. Participants join the network through authorization and form interest-related consortiums to jointly maintain blockchain operation.

In the blockchain network, two transaction models are generally used, that is, an unspent transaction output (UTXO) model and an account model. A typical application scenario of the UTXO model is the Bitcoin blockchain. An on-chain asset in the model exists in a form of transaction output. When an unspent transaction output exists in a transaction, the unspent transaction output belongs to a private key holder. In use, one or more unspent transaction outputs can be used as inputs and one or more outputs can be specified, resulting in a new unspent transaction output or outputs. Although the UTXO model is adopted by multiple blockchain networks, the support for smart contracts is very weak, which limits the application scenarios. A typical application scenario of the account model is the Ethereum blockchain. In this model, an account is created to represent an on-chain asset held by the account as a balance corresponding to an account address. Each transfer transaction can transfer an asset from one account address to another account address, and a transaction amount is directly updated to the balance corresponding to the account address. Compared with the UTXO model, the account model supports complete smart contract functions and has better scenario extensibility.

By using a distributed architecture used in a blockchain network and a chain structure used in a block, information can be permanently stored, without being tampered with, in a blockchain ledger uniformly maintained by all blockchain nodes. However, information privacy cannot be guaranteed due to full disclosure of the blockchain ledgers. For example, any user can query a blockchain ledger on any blockchain node to learn of information such as an asset held by a user and a transfer amount of a transaction. The information can be sensitive and need to be hidden. Therefore, a commitment-based confidential transaction scheme is proposed in an existing technology. Sensitive data such as an account balance, an asset amount, and a transaction remittance amount recorded in a blockchain ledger can be converted into a corresponding commitment amount, so as to avoid directly recording a plaintext amount of the sensitive data in the blockchain ledger. For example, when the Pedersen commitment mechanism is used, assume that an original amount is t, and a corresponding commitment amount can be PC(r, t)=r×G+t×H, where G and H are generators of an elliptic curve, r is a random number, and a value of r is only controlled by a private person (for example, an account owner, an asset holder, and a transaction participant), so an irrelevant person cannot derive the original amount t only based on the value of PC(r, t). In addition, the commitment amount also has a homomorphic characteristic, for example, PC(r1, t1)-PC(r2, t2)=PC(r1-r2, t1-t2), so commitment amounts can directly participate in calculation in a transaction process.

Specifically, in the UTXO model, the transaction amount can be protected by using homomorphic encryption or a homomorphic commitment technology, and a transaction output is ensured to be non-negative by using a range proof (RP) technology. In the account model, the transaction amount can be protected by using the homomorphic encryption or the homomorphic commitment technology, and the transaction amount can be ensured to be non-negative and the account balance to be sufficient by using the RP technology.

In the UTXO model, one or more transaction outputs are used as inputs of a transfer transaction, and one or more new transaction outputs are formed after the transfer is completed. It can be seen that one transaction output is only spent on one transfer transaction and cannot be spent on multiple transfer transactions, so an RP generated for one transfer transaction is only related to an input of the transfer transaction and not related to other transfer transactions. Therefore, the UTXO model naturally has high transaction concurrency. However, the UTXO model can cause the number of assets in a blockchain network to be much larger than the number of users, which can pose a great challenge to blockchain storage. In addition, as mentioned above, the UTXO model has weak support for smart contracts, which limits the application scenarios of the UTXO model.

The account model can cope with the challenges posed by the UTXO model to blockchain storage and expand more application scenarios by supporting smart contracts. However, in the account model, an input of each transaction is an account balance, and an RP of each transaction is related to the account balance. The account balance is updated after each transaction, so all transactions under the same account need to be executed serially. That is, only after one transaction ends and the account balance is updated, an RP can be generated for the next transaction to trigger the next transaction. Otherwise, the transaction will be rejected by a consensus node because the RP is invalid. Therefore, using a privacy protection technology with an RP in the account model seriously hampers transaction throughput.

To solve the concurrent problems under the account model and ensure adequate support for the smart contract function, the present specification proposes improvements to the account model in existing technologies to enable the account model to adapt to concurrent transactions with high throughput. The following describes related solutions in the present specification with reference to implementations.

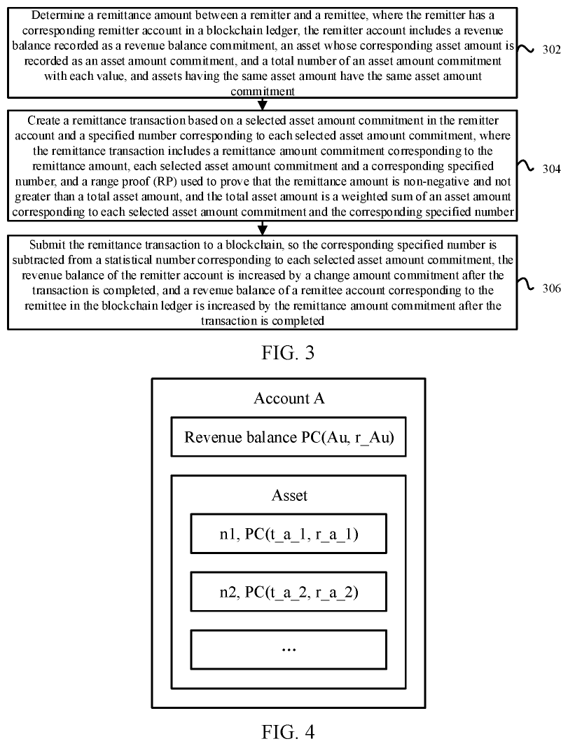

FIG. 3 is a flowchart illustrating a method for implementing a confidential transaction in a blockchain network, according to an exemplary implementation. As shown in FIG. 3, the method is applied to a remitter device and can include the following steps:

Step 302: Determine a remittance amount between a remitter and a remittee, where the remitter has a corresponding remitter account in a blockchain ledger, the remitter account includes a revenue balance recorded as a revenue balance commitment, an asset whose corresponding asset amount is recorded as an asset amount commitment, and a total number of an asset amount commitment with each value, and assets having the same asset amount have the same asset amount commitment.

The remittance amount can be negotiated between the remitter and the remittee, or can be determined by the remitter alone. Based on the determined remittance amount, a proper asset can be selected from the remitter account for paying the remittance amount.

The remitter corresponds to the remitter account, and the remittee corresponds to a remittee account. Both the remitter account and the remittee account are recorded in the blockchain ledger. Each blockchain node in the blockchain network maintains one blockchain ledger. A consensus-based mechanism ensures that content of the blockchain ledger maintained by all the blockchain nodes are consistent. Therefore, it can be considered that all the blockchain nodes jointly maintain one blockchain ledger.

As mentioned above, the present specification improves the account model in the existing technology. For example, FIG. 4 is a schematic diagram illustrating a blockchain ledger structure, according to an exemplary implementation. Assume that the remitter account is account A shown in FIG. 4, and account A includes a revenue balance and asset information. The plaintext amount of the revenue balance is Au, and for confidentiality, the revenue balance is specifically recorded as a corresponding revenue balance commitment PC(Au, r_Au) in the blockchain ledger, where r_Au is a random number.

The asset information is used to record the asset held by the remitter, and is generated based on a balance held by the remitter and is different from the transaction output in the UTXO model. For example, based on the plaintext amount balance t_a_1 held by the remitter, a corresponding commitment amount PC(t_a_1, r_a_1) can be generated in combination with a random number r_a_1. This is equivalent to that the remitter holds an asset whose asset amount is t_a_1 and whose asset amount commitment is PC(t_a_1, r_a_1). Similarly, a corresponding commitment amount PC(t_a_2, r_a_2) can be generated based on a plaintext amount balance t_a_2 held by the remitter and a random number r_a_2. This is equivalent to that the remitter holds an asset whose asset amount is t_a_2 and whose asset amount commitment is PC(t_a_2, r_a_2). By analogy, other assets with the same or different assets can be generated.

For different assets with the same asset amount, it can be limited in the present specification that asset amounts with the same value necessarily have the same random number. For example, the asset amount t_a_1 necessarily corresponds to the random number r_a_1, and the asset amount t_a_2 necessarily corresponds to the random number r_a_2, so the asset amounts with the same value necessarily correspond to asset amount commitments with the same value. For example, the asset amount t_a_1 necessarily corresponds to the asset amount commitment PC(t_a_1, r_a_1), and the asset amount t_a_2 necessarily corresponds to the asset amount commitment PC(t_a_2, r_a_2). Therefore, the asset information included in the remitter account can specifically include an asset amount commitment with each value and a total number of the asset amount commitment with each value. For example, in account A shown in FIG. 4, a total number corresponding to the asset amount commitment PC(t_a_1, r_a_1) is n1, and a total number corresponding to the asset amount commitment PC(t_a_2, r_a_2) is n2. That is, the remitter holds n1 asset amount commitments with the value PC(t_a_1, r_a_1), and n2 asset amount commitments with the value PC PC(t_a_2, r_a_2). As such, it is equivalent to dividing the asset included in the remitter account into groups, all assets of each asset group are corresponding to asset amounts (or asset amount commitments) with the same predetermined value, and assets of different asset groups are corresponding to asset amounts (or asset amount commitments) with different predetermined values. Certainly, all assets can correspond to asset amounts (or asset amount commitments) with the same predetermined value, which is equivalent to that only one asset group exists.

When the asset included in the remitter account is recorded based on the previous method, only an asset amount commitment corresponding to each asset group and a total number corresponding to each asset group need to be recorded. For example, in FIG. 4, an asset amount commitment corresponding to one asset group is PC(t_a_1, r_a_1) and a total number is n1, and an asset amount commitment corresponding to another asset group is PC(t_a_2, r_a_2) and a total number is n2. Therefore, detailed information of each asset does not need to be recorded separately, so when the asset changes, only a value of the corresponding total number needs to be adjusted. Therefore, maintenance costs of the asset information can be greatly reduced, and storage pressure can be alleviated.

Similar to the remitter account, a remittee account also includes the revenue balance and the asset information. The revenue balance is recorded as a revenue balance commitment. The asset information includes each value of an asset amount commitment and a total number of the value. Assets having the same asset amount have the same asset amount commitment. Details are omitted here.

Step 304: Create a remittance transaction based on a selected asset amount commitment in the remitter account and a specified number corresponding to each selected asset amount commitment, where the remittance transaction includes a remittance amount commitment corresponding to the remittance amount, each selected asset amount commitment and a corresponding specified number, and an RP used to prove that the remittance amount is non-negative and not greater than a total asset amount, and the total asset amount is a weighted sum of an asset amount corresponding to each selected asset amount commitment and the corresponding specified number.

Based on the remittance amount between the remitter and the remittee, one or more asset amount commitments contained in the remitter account and a specified number corresponding to each selected asset amount commitment can be selected. For example, when the remittance amount is t, if the selected asset amount commitments are PC(t_a_1, r_a_1) and PC(t_a_2, r_a_2), and the corresponding specified numbers are x1 and x2, the total asset amount can be determined as (t_a_1*x1+t_a_2*x2), and it should be ensured 0≤t≤(t_a_1*x1+t_a_2*x2). Specifically, an RP used to prove that the remittance amount is non-negative and not greater than the total asset amount can be generated, so whether 0≤t_a_1*x1++t_a_2*x2) is satisfied can be verified based on the RP without exposing plaintext values of the remittance amount and the total asset amount.

Step 306: Submit the remittance transaction to a blockchain, so the corresponding specified number is subtracted from a total number corresponding to each selected asset amount commitment, the revenue balance of the remitter account is increased by a change amount commitment after the transaction is completed, and a revenue balance of a remittee account corresponding to the remittee in the blockchain ledger is increased by the remittance amount commitment after the transaction is completed.

After the remittance transaction is submitted to the blockchain, the remittance transaction can be packaged into a block by a certain blockchain node, and the block is added to the blockchain after obtaining consensus, so the remittance transaction included in the block is executed on all blockchain nodes. Certainly, the blockchain node can verify the remittance transaction, such as verifying a signature of the remitter, a signature of the remittee, and verifying the above-mentioned RP, so the remittance transaction is allowed to be executed after the verification succeeds; otherwise, the execution can be rejected.

An input of the remittance transaction comes from the asset in the remitter account, and an output includes two parts: One part is that an output target is the remittee account, and an output amount is the remittance amount (actually recorded as the remittance amount commitment), and the other part is that an output target is the remitter account, and an output amount is a change amount (actually recorded as the change amount commitment). The change amount is the difference between the total asset amount and the remittance amount. For example, when the total asset amount is (t_a_1*x1+t_a_2*x2) and the remittance amount is t, it can be determined that the change amount t′=t_a_1*x1+t_a_2*x2-t, and the change amount commitment is PC(t′, r′), where r′ is a random number.

It can be seen that, based on the improved account model in the present specification, the revenue balance is dedicated to implementing collection (the revenue balance of the remitter is added to the change amount, and the revenue balance of the remittee is added to the remittance amount), and the asset is dedicated to implementing remittance, so collection and remittance of the same account can be decoupled. Therefore, a user can be involved in both remittance transactions TX1 and TX2 as a remitter of the remittance transaction TX1 and as a remittee of the remittance transaction TX2, thereby implementing concurrent transactions in the account model and improving transaction execution efficiency in the blockchain network.

In addition, when the RP is generated between the above-mentioned remittance amount and the total asset amount, the value of the total asset amount is only related to the selected asset amount commitment and the specified number, and does not involve a total number of each asset amount commitment recorded in the blockchain ledger, so different remittance transactions can separately generate corresponding RPs and do not affect each other. Further, a total number of an asset amount commitment with each value is recorded in a plaintext form in the blockchain ledger, so a blockchain node can directly compare a specified number included in a remittance transaction with a total number recorded in the blockchain ledger. If the specified number is not greater than the total number, the corresponding remittance transaction is allowed to be executed; otherwise, the corresponding remittance transaction is not allowed to be executed. Therefore, one user can simultaneously serve as remitters of multiple remittance transactions, to implement concurrent transactions in the account model, thereby improving transaction execution efficiency in the blockchain network. In addition, when a remittance transaction generated later arrives preferentially at a blockchain node, the blockchain node can preferentially process the later generated remittance transaction without waiting for complete execution of the earlier generated remittance transaction, thereby avoiding transaction congestion at the blockchain node.

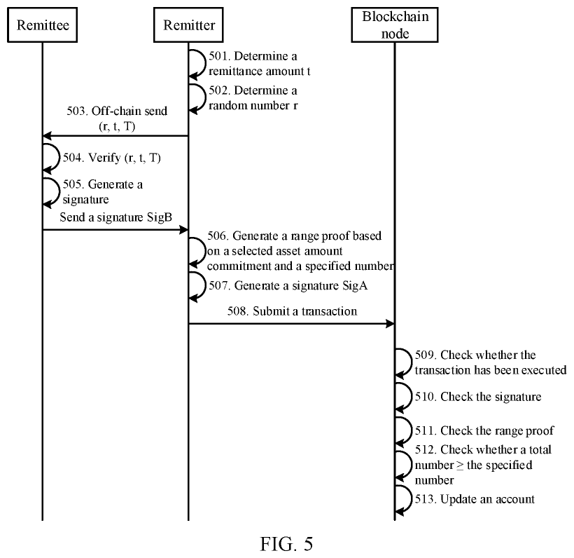

For example, the following uses user A as a remitter and user B as a remittee to describe an implementation process of the remittance transaction in the present specification. FIG. 5 is a flowchart illustrating a privacy-protected remittance transaction, according to an exemplary implementation. As shown in FIG. 5, interaction processes among a remitter, a remittee, and a blockchain node can include the following steps:

Step 501: The remitter determines a remittance amount t.

At the time of drafting a remittance transaction, the remittance amount t can be negotiated between the remitter and the remittee. Certainly, the remitter can determine the remittance amount t alone, and then the remittance amount t is confirmed by the remittee in subsequent steps. The remitter refers to the role of remitting money and assets in the remittance transaction, and the remittee refers to the role of receiving money and assets in the remittance transaction. For example, when user A sends a remittance to user B, user A is a remitter and user B is a remittee. In addition, when user B sends a remittance to user A, user B is a remitter and user A is a remittee. Therefore, the roles of the remitter and the remittee are not bound to the users, and the roles need to be determined based on actual remittance relationships.

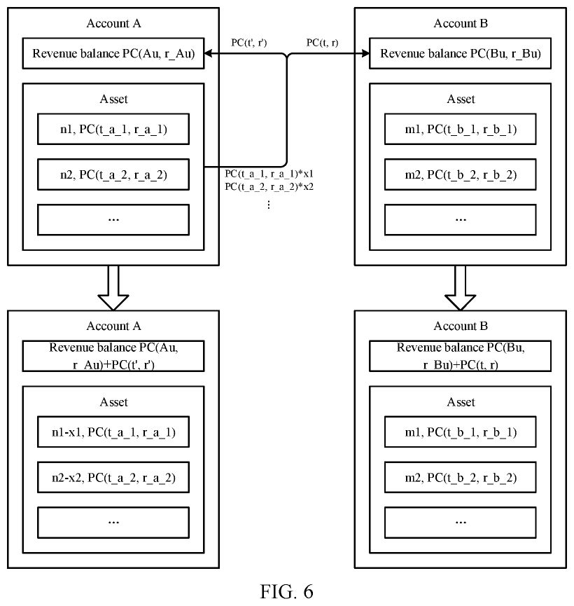

Assume that user A serves as the remitter and user B serves as the remittee, and user A sends a remittance to user B. FIG. 6 is a schematic diagram illustrating account changes before and after a remittance, according to an exemplary implementation. As shown in FIG. 6, assume that account A corresponding to user A exists on a blockchain ledger, and account B corresponding to user B exists on the blockchain ledger. As mentioned above, account A can include a revenue balance and asset information, where the revenue balance is recorded as PC(Au, r Au), and the asset information is recorded as [n1, PC(t_a_1, r_a_1)], [n2, PC(t_a_2, r_a_2)], etc. A total number indicating an asset in account A corresponding to an asset amount commitment PC(t_a_1, r_a_1) is n1, a total number of an asset corresponding to an asset amount commitment PC(t_a_2, r_a_2) is n2, etc. Similarly, account B can include a revenue balance and asset information, where the revenue balance is recorded as PC(Bu, r_Bu), and the asset information is recorded as [m1, PC(t_b_1, r_b_1)], [m2, PC(t_b_2, r_b_2)], etc. A total number indicating an asset in account B corresponding to an asset amount commitment PC(t_b_1, r_b_1) is m1, a total number of an asset corresponding to an asset amount commitment PC(t_b_2, r_b_2) is m2, etc.

Step 502: The remitter determines a random number r corresponding to the remittance amount t.

After the remitter generates the random number r for the remittance amount t, the remittance amount t can be processed based on the random number r to obtain a corresponding remittance amount commitment T=PC(t,r). For example, when the Pedersen commitment mechanism is used, T=PC(t,r)=r*G+t*H.

Step 503: The remitter sends (r, t, T) to the remittee through an off-chain channel.

By sending (r, t, T) through an off-chain channel rather than a blockchain network, the remittance random number r and the remittance amount t can be prevented from being recorded in the blockchain ledger, ensuring that the remittance amount t is unknown except for the remitter and the remittee.

Step 504: The remittee verifies the received (r, t, T).

The remittee can verify the remittance amount t to determine that the remittance amount t is a remittance amount expected to receive. For example, when the remittance amount commitment T is generated based on the Pedersen commitment mechanism, the remittee can verify the remittance amount commitment T, that is, the remittee can calculate the random number r and the remittance amount t by using the Pedersen commitment mechanism to verify whether the remittance amount commitment T=PC(t,r) is correct. If yes, it indicates that the verification succeeds; otherwise, the verification fails.

Step 505: After the verification succeeds, the remittee generates a signature and returns the signature to the remitter.

After the verification succeeds, the remittee can use the remittee's private key to sign (A, B:T) to generate a signature SigB and return the signature to the remitter. This SigB indicates that the remittee agrees that account A corresponding to the remitter shall implement the remittance transaction with the remittance amount commitment T to account B corresponding to the remittee.

Step 506: After receiving the signature SigB, the remitter generates an RP based on a selected asset amount commitment and a specified number.

As described above, account A shown in FIG. 6 includes several asset amount commitments and corresponding total numbers. For example, a total number corresponding to an asset amount commitment PC(t_a_1, r_a_1) is n1, and a total number corresponding to an asset amount commitment PC(t_a_2, r_a_2) is n2. Similar to the remittance amount t, the asset amount commitment PC(t_a_1, r_a_1) is calculated based on the asset amount t_a_1 and the random number r_a_1, and the asset amount commitment PC(t_a_2, r_a_2) is calculated based on the asset amount t_a_2 and the random number r_a_2. In addition, in the present specification, the asset amount commitment corresponding to the asset amount is calculated based on the following conditions: When asset amounts of different assets are the same, correspondingly selected random numbers are also the same, so as to ensure that multiple assets with the same asset amount can generate the same asset amount commitment. Therefore, multiple assets corresponding to the same asset amount commitment exist in the same account. In addition, these assets do not need to be specially focused, recorded or distinguished, and only a value and an asset number (that is, a total number) of the asset amount commitment need to be recorded. When these assets are spent, only asset amount commitments corresponding to the assets need to be determined, and corresponding total numbers need to be adjusted based on the spending status. This is described in detail below.

Depending on the value of the remittance amount t, a suitable asset portfolio can be selected to meet remittance requirements. Assume that the remittance amount is t=215, t_a_1=20, and t_a_2=100, one asset whose asset amount is t_a_1 and two assets whose asset amount is t_a_2 can be selected to obtain t_a_1+t_a_2*2=220>t=215 through combination, to meet the remittance requirements. Therefore, the remitter can select the asset amount commitment PC(t_a_1, r_a_1) and the asset amount commitment PC(t_a_2, r_a_2), and set the specified number corresponding to the asset amount commitment PC(t_a_1, r_a_1) to x1=1 and the specified number corresponding to the asset amount commitment PC(t_a_2, r_a_2) to x2=2.

Accordingly, the remitter can generate an RP based on the selected asset amount commitments PC(t_a_1, r_a_1) and PC(t_a_2, r_a_2), the corresponding specified quantities x1 and x2, and the remittance amount t. The RP is used to prove that 0≤t≤(t_a_1*x1+t_a_2*x2). In the present specification, the RP can be generated by using the Bulletproofs solution, Borromean ring signature solution, etc. in the existing technology, which is not limited in the present specification. A blockchain node can verify, in a ciphertext status, whether “0≤t_a_1*x1+t_a_2*x2)” is valid, so as to ensure that the remittance transaction is eligible and avoid exposing plaintext values of the remittance amount t, the asset amount t_a_1, the asset amount t_a_2, etc.

In addition, according to the RP generation process, it can be determined that the RP is independent of a total number of each asset amount commitment in account A. Therefore, in addition to the remittance transaction, account A can participate in other remittance transactions at the same time, and the RP can be successfully generated without mutual influence, thereby implementing concurrent transactions.

Step 507: The remitter signs transaction content {A, B:T, [PC(t_a_1, r_a_ 1), x1; PC(t_a_2, r_a_2), x2], RP;SigB} to generate a signature SigA.

The remitter can sign the transaction content {A, B:T, [PC(t_a_1, r_a_1), x1; PC(t_a_2, r_a_2), x2], RP;SigB} by using the remitter's private key to generate the signature SigA.

Step 508: The remitter submits the transaction to the blockchain.

The remitter can submit the remittance transaction to a certain blockchain node in the blockchain network, and the remittance transaction can further be transmitted to all blockchain nodes in the blockchain network. Each blockchain node verifies the remittance transaction to perform a remittance operation when the verification succeeds, or reject the remittance when the verification fails.

Step 509: The blockchain node checks whether the transaction has been executed.

The blockchain node here can represent any blockchain node in the blockchain network, that is, each blockchain node in the blockchain network receives the remittance transaction and performs operations such as verification by using steps 509 to 512.

After receiving the remittance transaction, the blockchain node can use the anti-double-spending or anti-replay attack mechanism in the existing technology to verify whether the remittance transaction has been executed. If executed, the blockchain node can reject the remittance transaction; otherwise, the blockchain node proceeds to step 510.

Step 510: The blockchain node checks the signature.

In an implementation, the blockchain node can check if the signatures SigA and SigB included in the remittance transaction are correct; if not correct, the blockchain node can reject the remittance transaction; otherwise, proceeds to step 511.

Step 511: The blockchain node checks the RP.

In an implementation, the blockchain node can check the RP included in the remittance transaction based on the RP technology to determine whether 0≤t≤(t_a_1*x1+t_a_2*x2) is satisfied. If not satisfied, the blockchain node can reject the remittance transaction; otherwise, proceeds to step 512.

Step 512: The blockchain node checks whether the total number is not less than the specified number.

Because the total number corresponding to each asset amount commitment in account A is recorded in the blockchain ledger in plaintext, and the specified number is also recorded in the remittance transaction in plaintext, the blockchain node can directly compare the total number with the specified number to determine whether account A is sufficient to pay. As shown in FIG. 6, because the total number of the asset amount commitment PC(t_a_1, r_a_1) is n1, the total number of the asset amount commitment PC(t_a_2, r_a_2) is n2, the specified number corresponding to the asset amount commitment PC(t_a_1, r_a_1) in the remittance transaction is x1, and the specified number corresponding to the asset amount commitment PC(t_a_2, r_a_2) is x2, as long as it is determined that n1≥x1 and n2≥x2, it indicates that account A is sufficient to pay and perform the remittance transaction.

In addition, with the plaintext comparison, it is not necessary to add an RP in the remittance transaction to prove that account A is sufficient to pay. As such, an RP generation process can be reduced, improving transaction generation efficiency, and an RP verification process can be reduced, improving transaction execution efficiency.

Step 513: The blockchain node updates ledgers respectively corresponding to user A and user B in the maintained blockchain ledger.

After the verification in steps 509 to 512 succeeds, the blockchain node can separately update account A and account B recorded in the blockchain ledger, as shown in FIG. 6.

In account A, the revenue balance before the transaction is Au and is recorded as a corresponding revenue balance commitment PC(Au, r_Au) in the blockchain ledger. The total number corresponding to the asset amount commitment PC(t_a_1, r_a_1) before the transaction is n1, and the total number corresponding to the asset amount commitment PC(t_a_2, r_a_2) before the transaction is n2. After the transaction is completed, the total number corresponding to the asset amount commitment PC(t_a_1, r_a_1) decreases by x1 and is updated to n1-x1, and the total number corresponding to the asset amount commitment PC(t_a_2, r_a_2) decreases by x2 and is updated to n2-x2. In addition, the revenue balance increases by a change amount t′, which corresponds to a change amount commitment PC(t′, r′). Therefore, the revenue balance commitment recorded in the blockchain ledger is updated to PC(Au, r Au)+PC(t′, r′). It is worthwhile to note that, although not specifically described above, the change amount commitment PC(t′, r′) is also included in the above-mentioned remittance transaction, so the blockchain node can update the revenue balance of account A based on the change amount commitment PC(t′, r′) when executing the remittance transaction.

In account B, the revenue balance before the transaction is Bu and is recorded as a corresponding revenue balance commitment PC(Bu, r_Bu) in the blockchain ledger. The total number corresponding to the asset amount commitment PC(t_b_1, r_b_1) before the transaction is m1, and the total number corresponding to the asset amount commitment PC(t_b_2, r_b_2) before the transaction is m2. After the transaction is completed, the total numbers m1 and m2 remain unchanged, while the revenue balance Bu increases by the remittance amount t. Therefore, the revenue balance is recorded as a corresponding revenue balance commitment PC(Bu, r_Bu)+PC(t,r) in the blockchain ledger.

As described above, when the account includes the revenue balance and the asset information, input and output decoupling of the account can be implemented while transaction privacy is ensured, thereby implementing high-concurrency transfer under the account model. However, because all funds transferred into the account are recorded in the revenue balance, and all funds transferred out are deducted from the asset information (the value of the total number is decreased), the value of the total number (that is, the asset in the account) is decreasing, and can be smaller than the specified number in the remittance transaction, which affects execution of the remittance transaction. To ensure that the total number is always sufficient to complete the transaction, the total number can be adjusted periodically or at any time by recharging.

Taking a recharging process of the remitter account as an example, a recharging transaction can be created, where the recharging transaction includes an asset amount commitment with at least one specified value and a corresponding recharging number, and an RP used to prove that the revenue balance of the remitter account is not less than a recharging amount. The recharging amount is a weighted sum of an asset amount corresponding to an asset amount commitment with a specified value and a recharging number (if only one asset amount commitment with a specified value is involved, the recharging amount is a product of an asset amount corresponding to the asset amount commitment and the recharging number). The recharging transaction is submitted to the blockchain, so a total number of an asset amount commitment corresponding to the specified value in the remitter account increases by the corresponding recharging number after the transaction is completed, and the revenue balance of the remitter account decreases by the weighted sum of the asset amount commitment with the at least one specified value and the corresponding recharging number after the transaction is completed. In other words, at least one part of the revenue balance in the remitter account can be separated and converted into corresponding assets. These assets can increase values of total numbers of corresponding asset amount commitments. Certainly, the remittee account can also be recharged in the previous method.

Although the asset recharging operation based on the revenue balance can be implemented in the previous method, when the account participates in frequent remittance transactions and a large amount of remittance, the previous method can cause frequent recharging. As a result, the revenue balance frequently participates in transfer-in and transfer-out (recharging) of funds, and even a transfer-in transaction (remittance transaction from another account to the account) and the recharging transaction affects each other, reducing efficiency.

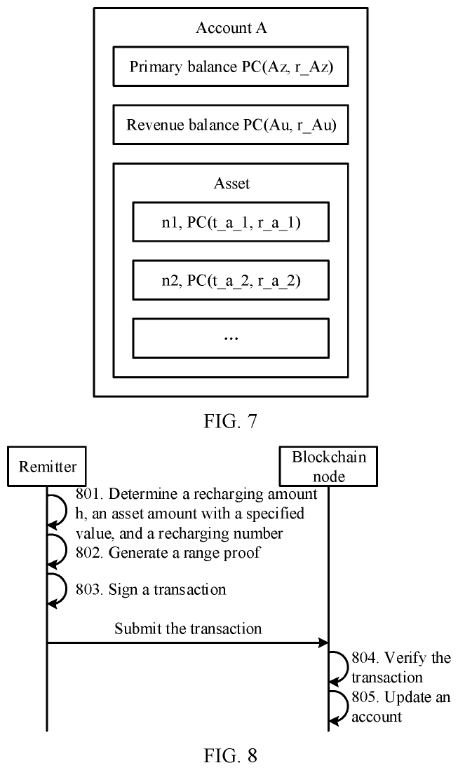

Therefore, the present specification proposes further improvements to the account structure shown in FIG. 4. For example, FIG. 7 is a schematic diagram illustrating another blockchain ledger structure, according to an exemplary implementation. Account A is still used as an example. On the basis of the account structure shown in FIG. 4, in addition to the revenue balance and the asset information, account A shown in FIG. 7 can include a primary balance, that is, account A includes three parts in total: the primary balance, the revenue balance, and the asset information. The revenue balance is specially used to receive a transaction amount of a transfer-in transaction, and the asset information is specially used to participate in a transfer-out transaction. The primary balance is used to recharge the asset information, to prevent the revenue balance from performing a recharging task and avoid impact described above.

Taking the remitter as an example, the remitter can create a recharging transaction. The recharging transaction includes an asset amount commitment with at least one specified value and a corresponding recharging number, and an RP used to prove that the primary balance is not less than the recharging amount. The recharging amount is a weighted sum of an asset amount corresponding to the asset amount commitment with the at least one specified value and the corresponding recharging number. The recharging transaction is submitted to the blockchain, so a total number in the remitter account corresponding to the asset amount commitment with the at least one specified value increases by the corresponding recharging number after the transaction is completed, and the primary balance of the remitter account decreases by the weighted sum of the asset amount commitment with the at least one specified value and the corresponding recharging number after the transaction is completed. For example, FIG. 8 is a schematic interaction diagram illustrating asset recharging by using a primary balance, according to an example implementation. As shown in FIG. 8, the interaction process can include the following steps:

Step 801: The remitter determines an asset amount with a specified value and a recharging number.

The remitter can set the asset amount with the specified value and the recharging number. For example, if the recharging number corresponding to the asset amount with a value 100 is 3, and the recharging number corresponding to the asset amount with a value 20 is 5, the recharging amount in total this time can be determined as h=100*3+20*5=400.

The remitter can determine the asset amount corresponding to the asset amount commitment existing in the account, and use one or more asset amounts as the asset amount with the specified value, so total numbers corresponding to the existing asset amount commitments can be increased accordingly after recharging is completed. Or the remitter can set another asset amount different from an asset amount corresponding to an existing asset amount commitment. For example, when an asset amount commitment corresponding to an asset with a value 100 and an asset amount commitment corresponding to an asset with a value 20 exist in the account, the specified value can be set to 50, so an asset amount commitment corresponding to an asset with a value 50 is obtained through recharging, and a total number of the asset amount commitment corresponding to the asset with a value 50 can be added to the asset information included in the account.

Although the remitter can manually initiate a recharging transaction, an automated recharging operation can be implemented in an implementation. For example, a threshold level value can be set for a total number of an asset amount commitment with each value in the account. When a total number corresponding to an asset amount commitment with a certain value is lower than a corresponding threshold level value, a recharging transaction can be initiated automatically to recharge the asset amount commitment with this value, so the corresponding total number rises to a value not lower than the threshold level value.

Step 802: The remitter generates an RP.

In an implementation, because the value Az of the primary balance is recorded as a corresponding commitment amount PC(Az, r_Az) in the blockchain ledger, where r_Az is a random number, it is necessary to generate the RP to verify that the value Az of the primary balance is ≥recharging amount h≥0.

Step 803: After signing the transaction, the remitter submits the signature to the blockchain.

Based on the previous steps, the transaction content of the recharging transaction generated by the remitter can be Topup{A: [PC(t_a_1, r_a_1),y1;PC(t_a_2, r_a_2),y2],PR}. “A” represents the account address of account A, and [PC(t_a_1, r_a_1),y1;PC(t_a_2, r_a_2),y2] indicates that the recharging target is the recharging number y1 of the asset amount commitment PC(t_a_1, r_a_1) and the recharging number y2 of the asset amount commitment PC(t_a_2, r_a_2) included in account A.

In addition, a type field can be added to the transaction, and when creating each transaction, the remitter can assign a value to the type field to mark a type of a submitted transaction, so as to distinguish among the remittance transaction, recharging transaction, merging transaction, primary balance remittance transaction, etc. involved in the present specification. For example, a remittance transaction can be marked with a value “Transfer”, and a recharging transaction can be marked with a value “Topup”.

The remitter signs the transaction content Topup{A:[PC(t_a_1, r_a_1),y1;PC(t_a_2, r_a_2),y2],PR} by using the held remitter private key, and submits a recharging transaction created after the signing to the blockchain network, so all blockchain nodes perform verification and execution.

Step 804: The blockchain node verifies the transaction.

The blockchain node can verify whether the signature of the recharging transaction is correct. If not, the transaction can be rejected.

The blockchain node can verify the RP included in the recharging transaction to determine whether 0≤(t_a_1*y1+t_a_2*y2)≤Az is satisfied; if not, can reject the transaction.

After all verification is passed, step 805 can be performed.

Step 805: The blockchain node updates the account.

After the verification in step 804 is passed, the blockchain node can update account A recorded in the blockchain ledger. For example, FIG. 9 is a schematic diagram illustrating account changes before and after recharging, according to an exemplary implementation. As shown in FIG. 9, the primary balance before the transaction is Az and is recorded as a corresponding commitment amount PC(Az, r_Az) in the blockchain ledger. The revenue balance before the transaction is Au and is recorded as a corresponding commitment amount PC(Au, r_Au) in the blockchain ledger. The asset amount commitment PC(t_a_1, r_a_1) before the transaction corresponds to the total number nl, and the asset amount commitment PC(t_a_2, r_a_2) corresponds to the total number n2.

After the transaction is completed, (t_a_1*y1+t_a_2*y2), which is a weighted sum of asset amounts with all values and recharging numbers, is deducted from the primary balance, which is therefore recorded as PC(Az, r_Az)-PC(t_a_1, r_a_1)*y1-PC(t_a_2, r_a_2)*y2 in the blockchain ledger. The total number n1 increases by the recharging number y1 and the total number n2 increases by the recharging number y2 in the asset information. Therefore, the total number n1 and the total number n2 are recorded as [n1+y1, PC(t_a_1, r_a_1)] and [n2+y2, PC(t_a_2, r_a_2)] in plaintext in the blockchain ledger. Meanwhile, the value of the revenue balance remains unchanged.

As the asset information in the account is constantly involved in transfer-out transactions, and the primary balance constantly recharges the asset information, the primary balance is gradually reduced. When the primary balance is reduced to a certain degree or 0, recharging cannot continue. Therefore, funds obtained from the revenue balance can be transferred to the primary balance so the account can participate in transfer-out transactions continuously.

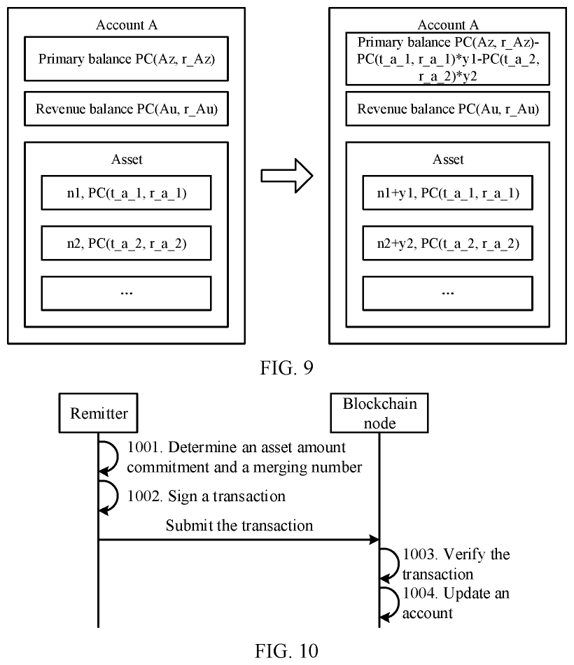

Taking the remitter as an example, the remitter can create a merging transaction containing an asset amount commitment with at least one specified value and a corresponding merging number; then, submit the merging transaction to the blockchain. As such, a total number in the remitter account corresponding to the asset amount commitment with the at least one specified value decreases by a corresponding merging number after the transaction is completed, the primary balance increases by a merging amount commitment after the transaction is completed, and/or the revenue balance of the remitter account is cleared after the transaction is completed, and the primary balance of the remitter account increases by a corresponding revenue balance commitment after the transaction is completed. The merging amount commitment is a weighted sum of the asset amount commitment with the at least one specified value and the corresponding merging number. In other words, the merging transaction can merge all funds contained in the revenue balance into the primary balance, or in some cases, can merge at least a portion of assets into the primary balance in the form of funds, or can merge the funds contained in the revenue balance into the primary balance and merge at least a portion of the assets into the primary balance in the form of funds. For example, FIG. 10 is a schematic interaction diagram illustrating a merging operation, according to an example implementation. As shown in FIG. 10, all funds in the revenue balance and an asset with a specified number can be merged into the primary balance in the interaction process, which specifically includes the following steps:

Step 1001: The remitter determines an asset amount commitment and a merging number.

By selecting an asset amount commitment with one or more values and a merging number corresponding to each asset amount commitment, an asset amount that the remitter wants to merge into the primary balance can be determined. For example, when the selected asset amount commitments are respectively PC(t_a_1, r_a_1) and PC(t_a_2, r_a_2), if a merging number corresponding to the asset amount commitment PC(t_a_1, r_a_1) is z1 and a merging number corresponding to the asset amount commitment PC(t_a_2, r_a_2) is z2, it can be determined that a corresponding merging amount is k=t_a_1*z1+t_a_2*z2.

Step 1002: After signing the transaction, the remitter submits the signature to the blockchain.

Based on the previous steps, the transaction content of the merging transaction generated by the remitter can be Merge{A: [PC(t_a_1, r_a_1),z1;PC(t_a_2, r_a_2),z2]}. “A” represents the account address of account A, indicating that a merging operation needs to be performed on account A. [PC(t_a_1, r_a_1),z1;PC(t_a_2, r_a_2),z2] indicates that an asset with a number z1 and a corresponding commitment PC(t_a_1, r_a_1) and an asset with a number z2 and a corresponding commitment PC(t_a_2, r_a_2) need to be merged into the primary balance. Merge indicates that a current transaction type is a merging transaction used to implement a merging operation on account A.

Because all funds of the revenue balance will be transferred to the primary balance, it is not necessary to generate an RP for fund transfer of the revenue balance. In addition, the asset information records each total number in the plaintext form, and the merging transaction records the merging number in the plaintext form. Therefore, the blockchain node can directly compare the total number with the merging number, so the transaction is completed when the total number is not less than the merging number; otherwise, transaction execution is not allowed, and no RP needs to be generated.

The remitter signs the transaction content Merge {A: [PC(t_a_1, r_a_1),z1;PC(t_a_2, r_a_2),z2]} by using the held remitter private key, and submits a merging transaction created after the signing to the blockchain network, so all blockchain nodes perform verification and execution.

Step 1003: The blockchain node verifies the transaction.

The blockchain node can verify whether the signature of the merging transaction is correct. If not, the transaction can be rejected.

The blockchain node can verify whether a merging number corresponding to each asset amount commitment in the previous merging transaction is not greater than a corresponding total number. For example, an asset amount commitment PC(t_a_1, r_a_1) is used as an example. Assume that a merging number recorded in the merging transaction is z1=2, and a total number recorded in the blockchain ledger is n1=5. Because z1<n1, the merging transaction is allowed for execution. If the merging number is z1=4 and the total number is n1=3, the merging transaction is not allowed for execution because z1>n1.

After all verification is passed, step 1004 can be performed.

Step 1004: The blockchain node updates the account.

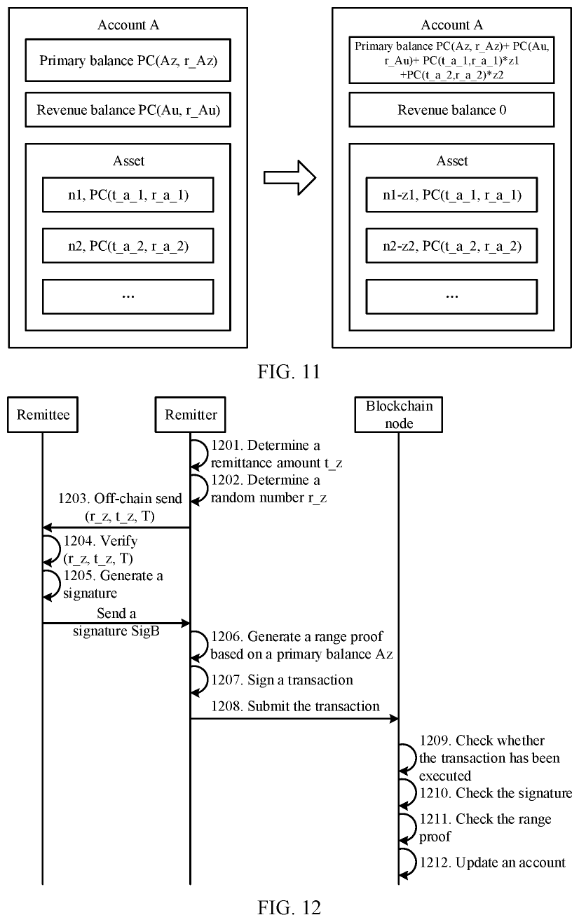

After the verification in step 1003 is passed, the blockchain node can update account A recorded in the blockchain ledger. For example, FIG. 11 is a schematic diagram illustrating account changes before and after merging, according to an exemplary implementation. As shown in FIG. 11, the primary balance before the transaction is Az and is recorded as a corresponding commitment amount PC(Az, r_Az) in the blockchain ledger. The revenue balance before the transaction is Au and is recorded as a corresponding commitment amount PC(Au, r_Au) in the blockchain ledger. The asset amount commitment PC(t_a_1, r_a_1) before the transaction corresponds to the total number n1, and the asset amount commitment PC(t_a_2, r_a_2) corresponds to the total number n2.

After the transaction is completed, the revenue balance changes to 0. The total number n1 corresponding to the asset amount commitment PC(t_a_1, r_a_1) decreases by the merging number z1 and is updated to n1-z1, while the total number n2 corresponding to the asset amount commitment PC(t_a_2, r_a_2) decreases by the merging number z2 and is updated to n2-z2. The primary balance increases by the total funds of the revenue balance, the asset amount commitment PC(t_a_1, r_a_1) of number z1, and the asset amount commitment PC(t_a_2, r_a_2) of number z2. Therefore, the primary balance commitment recorded in the blockchain ledger is updated to PC(Az, r_Az)+PC(Au, r_Au)+PC(t_a_1, r_a_1)*z1+PC(t_a_2, r_a_2)*z2.

In the implementations provided in the present specification, for the primary balance, the revenue balance, and the asset information included in the account, the asset information can participate in a transfer-out transaction, the revenue balance can participate in a transfer-in transaction (the revenue balance also collects a change amount in a transfer-out transaction), and the primary balance can participate in a recharging transaction and a merging transaction. This does not mean that each balance can participate only in the previous type of transaction. For example, the account structure of the present specification can also be compatible with a primary balance transfer transaction where the primary balance participates in fund transfer-out, as described below.

For the primary balance transfer transaction, a primary balance remittance transaction can be generated based on a primary balance transaction amount between the remitter and the remittee. The primary balance remittance transaction includes a primary balance transaction amount commitment corresponding to a primary balance transaction amount, and an RP used to prove that the primary balance transaction amount is non-negative and not greater than the primary balance. Then, the remitter can submit the primary balance remittance transaction to the blockchain, so the primary balance transaction amount commitment is deducted from the primary balance after the transaction is completed, and the revenue balance of the remittee account is increased by the primary balance transaction amount commitment after the transaction is completed. FIG. 12 is a flowchart illustrating a primary balance transfer transaction, according to an exemplary implementation. As shown in FIG. 12, an interaction process among a remitter, a remittee, and a blockchain node can include the following steps:

Step 1201: The remitter determines a remittance amount t_z.

At the time of drafting a remittance transaction, the remittance amount t_z can be negotiated between the remitter and the remittee. Certainly, the remitter can determine the remittance amount t_z alone, and then the remittance amount t_z is confirmed by the remittee in subsequent steps.

Step 1202: The remitter determines a random number r_z corresponding to the remittance amount t_z.

The remitter can generate the random number r_z for the remittance amount t_z. For example, based on the Pedersen commitment mechanism, a remittance commitment T=PC(t_z, r_z) corresponding to the remittance amount t_z can be calculated.

Step 1203: The remitter sends (r_z, t_z, T) to the remittee through an off-chain channel.

By sending (r_z, t_z, T) through an off-chain channel rather than a blockchain network, the remittance random number r_z and the remittance amount t_z can be prevented from being recorded in the blockchain ledger, ensuring that the remittance amount t z is unknowable except for the remitter and the remittee.

Step 1204: The remittee verifies the received (r_z, t_z, T).

The remittee can verify the remittance amount t_z to determine that the remittance amount t_z is a remittance amount expected to receive. In addition, the remittee can verify a remittance commitment T, that is, the remittee can calculate the random number r_z and the remittance amount t_z by using the Pedersen commitment mechanism to verify whether the remittance commitment T=PC(t_z,r_z) is correct. If the remittance commitment is correct, it indicates that verification succeeds; otherwise, verification fails.

Step 1205: After the verification succeeds, the remittee generates a signature and returns the signature to the remitter.

In an implementation, after the verification succeeds, the remittee can use the remittee's private key to sign (A, B:T) to generate a signature SigB and return the signature to the remitter. This SigB indicates that the remittee agrees that account A corresponding to the remitter shall implement the remittance transaction with the commitment T to account B corresponding to the remittee.

Step 1206: After receiving the signature SigB, the remitter generates an RP based on a primary balance Az.

In an implementation, to ensure successful completion of the remittance transaction, the blockchain node needs to determine that the remittance amount t_z and the primary balance Az meet the following conditions: 0≤t_z≤Az, so the remitter can use the RP technology to generate the RP for verification by the blockchain node in a subsequent process, and the blockchain node can verify whether a transaction meets the above conditions in a ciphertext state.

Step 1207: The remitter signs the transaction content PrimaryTransfer(A,B:T,RP;SigB) to generate a signature SigA.

The remitter can sign the transaction content PrimaryTransfer (A,B:T,RP;SigB) by using the remitter's private key to generate SigA. PrimaryTransfer is used to indicate that the transaction type is a primary balance transfer transaction, so the remittance amount t_z is deducted from the primary balance of account A.

Step 1208: The remitter submits the transaction to the blockchain.

The remitter submits the remittance transaction to a certain blockchain node in the blockchain network, and the remittance transaction is further transmitted to all blockchain nodes in the blockchain network. Each blockchain node verifies the remittance transaction to perform a remittance operation when the verification succeeds, or reject the remittance when the verification fails.

Step 1209: The blockchain node checks whether the transaction has been executed.

The blockchain node here can represent any blockchain node in the blockchain network, that is, each blockchain node in the blockchain network receives the remittance transaction and performs operations such as verification by using steps 1209 to 1211.

After receiving the remittance transaction, the blockchain node can use the anti-double-spending or anti-replay attack mechanism in the existing technology to verify whether the remittance transaction has been executed. If executed, the blockchain node can reject the remittance transaction; otherwise, the blockchain node proceeds to step 1210.

Step 1210: The blockchain node checks the signature.

The blockchain node can check if the signatures SigA and SigB included in the remittance transaction are correct; if not correct, the blockchain node can reject the remittance transaction; otherwise, proceeds to step 1211.

Step 1211: The blockchain node checks the RP.

The blockchain node can check, based on the RP technology, the RP included in the remittance transaction to determine whether 0≤t_z≤Az is satisfied. If not satisfied, the blockchain node can reject the remittance transaction; otherwise, proceeds to step 1212.

Step 1212: The blockchain node updates, in the maintained blockchain ledger, accounts A and B that are respectively corresponding to the remitter and the remittee.

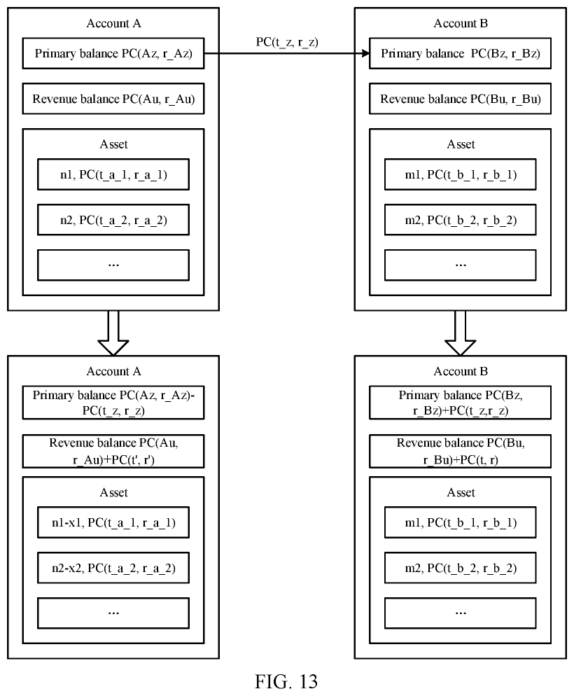

In an implementation, after verification in steps 1209 to 1211 succeeds, the blockchain node can separately update blockchain ledger 1 and blockchain ledger 2 that are recorded in the blockchain ledger. FIG. 13 is a schematic diagram illustrating account changes before and after a primary balance remittance, according to an exemplary implementation. As shown in FIG. 13, in account A, the primary balance before the transaction is Az and is recorded as a corresponding commitment amount PC(Az, r_Az) in the blockchain ledger. The revenue balance before the transaction is Au and is recorded as a corresponding commitment amount PC(Au, r_Au) in the blockchain ledger. The asset amount commitment PC(t_a_1, r_a_1) before the transaction corresponds to the total number n1, and the asset amount commitment PC(t_a_2, r_a_2) corresponds to the total number n2. After the transaction is completed, the above transaction amount t_z is deducted from the primary balance, so the primary balance is recorded as a corresponding commitment amount PC(Az, r_Az)-PC(t_z,r_z) in the blockchain ledger, while the revenue balance Au and the total number n1 and n2 remain unchanged.

In account B, the primary balance before the transaction is Bz and is recorded as a corresponding commitment amount PC(Bz, r_Bz) in the blockchain ledger. The revenue balance before the transaction is Bu and is recorded as a corresponding commitment amount PC(Bu, r_Bu) in the blockchain ledger. The asset amount commitment PC(t_b_1, r_b_1) before the transaction corresponds to the total number m1, and the asset amount commitment PC(t_b_2, r_b_2) corresponds to the total number m2. After the transaction is completed, the primary balance is Bz, the total number n1 and n2 remains unchanged, and the revenue balance increases by the remittance amount t_z. Therefore, the revenue balance is recorded as a corresponding commitment amount PC(Bu, r_Bu)+PC(t_z,r_z) in the blockchain ledger.

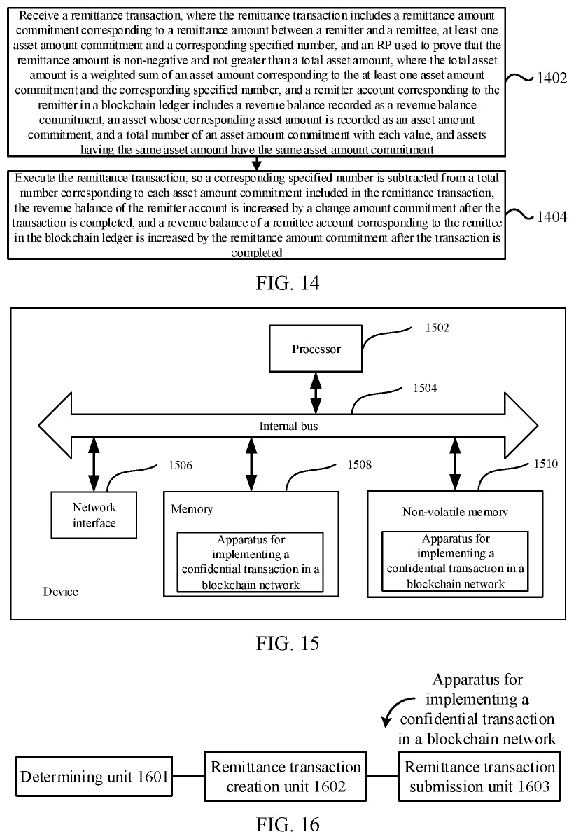

FIG. 14 is a flowchart illustrating a method for implementing a confidential transaction in another blockchain network, according to an exemplary implementation. As shown in FIG. 14, the method is applied to a blockchain node and can include the following steps:

Step 1402: Receive a remittance transaction, where the remittance transaction includes a remittance amount commitment corresponding to a remittance amount between a remitter and a remittee, at least one asset amount commitment and a corresponding specified number, and an RP used to prove that the remittance amount is non-negative and not greater than a total asset amount, where the total asset amount is a weighted sum of an asset amount corresponding to the at least one asset amount commitment and the corresponding specified number, and a remitter account corresponding to the remitter in a blockchain ledger includes a revenue balance recorded as a revenue balance commitment, an asset whose corresponding asset amount is recorded as an asset amount commitment, and a total number of an asset amount commitment with each value, and assets having the same asset amount have the same asset amount commitment.

The remittance amount can be negotiated between the remitter and the remittee, or can be determined by the remitter alone. Based on the determined remittance amount, a proper asset can be selected from the remitter account for paying the remittance amount.

The remitter corresponds to the remitter account, and the remittee corresponds to the remittee account. Both the remitter account and the remittee account are recorded in the blockchain ledger. Each blockchain node in the blockchain network maintains one blockchain ledger. A consensus-based mechanism ensures that content of the blockchain ledger maintained by all the blockchain nodes are consistent. Therefore, it can be considered that all the blockchain nodes jointly maintain one blockchain ledger.

As mentioned above, the present specification improves the account model in the existing technology. For example, as shown in FIG. 4, account A includes a revenue balance and asset information. The plaintext amount of the revenue balance is Au, and for confidentiality, the revenue balance is specifically recorded as a corresponding revenue balance commitment PC(Au, r_Au) in the blockchain ledger, where r Au is a random number. The asset information is used to record the asset held by the remitter, and is generated based on a balance held by the remitter and is different from the transaction output in the UTXO model. For example, based on the plaintext amount balance t_a_1 held by the remitter, a corresponding commitment amount PC(t_a_1, r_a_1) can be generated in combination with a random number r_a_1. This is equivalent to that the remitter holds an asset whose asset amount is t_a_1 and whose asset amount commitment is PC(t_a_1, r_a_1). Similarly, a corresponding commitment amount PC(t_a_2, r_a_2) can be generated based on a plaintext amount balance t_a_2 held by the remitter and a random number r_a_2. This is equivalent to that the remitter holds an asset whose asset amount is t_a_2 and whose asset amount commitment is PC(t_a_2, r_a_2). By analogy, other assets with the same or different assets can be generated.

For different assets with the same asset amount, it can be limited in the present specification that asset amounts with the same value necessarily have the same random number. For example, the asset amount t_a_1 necessarily corresponds to the random number r_a_1, and the asset amount t_a_2 necessarily corresponds to the random number r_a_2, so the asset amounts with the same value necessarily correspond to asset amount commitments with the same value. For example, the asset amount t_a_1 necessarily corresponds to the asset amount commitment PC(t_a_1, r_a_1), and the asset amount t_a_2 necessarily corresponds to the asset amount commitment PC(t_a_2, r_a_2). Therefore, the asset information included in the remitter account can specifically include an asset amount commitment with each value and a total number of the asset amount commitment with each value. For example, in account A shown in FIG. 4, a total number corresponding to the asset amount commitment PC(t_a_1, r_a_1) is n1, and a total number corresponding to the asset amount commitment PC(t_a_2, r_a_2) is n2. That is, the remitter holds n1 asset amount commitments with the value PC(t_a_1, r_a_1), and n2 asset amount commitments with the value PC PC(t_a_2, r_a_2). As such, it is equivalent to dividing the asset included in the remitter account into groups, all assets of each asset group are corresponding to asset amounts (or asset amount commitments) with the same predetermined value, and assets of different asset groups are corresponding to asset amounts (or asset amount commitments) with different predetermined values. Certainly, all assets can correspond to asset amounts (or asset amount commitments) with the same predetermined value, which is equivalent to that only one asset group exists.

When the asset included in the remitter account is recorded based on the previous method, only an asset amount commitment corresponding to each asset group and a total number corresponding to each asset group need to be recorded. For example, in FIG. 4, an asset amount commitment corresponding to one asset group is PC(t_a_1, r_a_1) and a total number is n1, and an asset amount commitment corresponding to another asset group is PC(t_a_2, r_a_2) and a total number is n2. Therefore, detailed information of each asset does not need to be recorded separately, so when the asset changes, only a value of the corresponding total number needs to be adjusted. Therefore, maintenance costs of the asset information can be greatly reduced, and storage pressure can be alleviated.

Similar to the remitter account, a remittee account also includes the revenue balance and the asset information. The revenue balance is recorded as a revenue balance commitment. The asset information includes each value of an asset amount commitment and a total number of the value. Assets having the same asset amount have the same asset amount commitment. Details are omitted here.

As mentioned above, one or more asset amount commitments selected in the remitter account and a specified number corresponding to each selected asset amount commitment are added to the remittance transaction. For example, when the remittance amount is t, if the selected asset amount commitments are PC(t_a_1, r_a_1) and PC(t_a_2, r_a_2), and the corresponding specified numbers are x1 and x2, the total asset amount can be determined as (t_a_1*x1+t_a_2*x2), and it should be ensured 0≤t≤(t_a_1*x1+t_a_2*x2). Specifically, an RP used to prove that the remittance amount is non-negative and not greater than the total asset amount can be generated, so whether 0≤t≤(t_a_1*x1+t_a_2*x2) is satisfied can be verified based on the RP without exposing plaintext values of the remittance amount and the total asset amount.

Step 1404: Execute the remittance transaction, so a corresponding specified number is subtracted from a total number corresponding to each asset amount commitment included in the remittance transaction, the revenue balance of the remitter account is increased by a change amount commitment after the transaction is completed, and a revenue balance of a remittee account corresponding to the remittee in the blockchain ledger is increased by the remittance amount commitment after the transaction is completed.

After the remittance transaction is submitted to the blockchain, the remittance transaction can be packaged into a block by a certain blockchain node, and the block is added to the blockchain after obtaining consensus, so the remittance transaction included in the block is executed on all blockchain nodes. Certainly, the blockchain node can verify the remittance transaction, such as verifying a signature of the remitter, a signature of the remittee, and verifying the above-mentioned RP, so the remittance transaction is allowed to be executed after the verification succeeds; otherwise, the execution can be rejected.

An input of the remittance transaction comes from the asset in the remitter account, and an output includes two parts: One part is that an output target is the remittee account, and an output amount is the remittance amount (actually recorded as the remittance amount commitment), and the other part is that an output target is the remitter account, and an output amount is a change amount (actually recorded as the change amount commitment). The change amount is the difference between the total asset amount and the remittance amount. For example, when the total asset amount is (t_a_1*x1+t_a_2*x2) and the remittance amount is t, it can be determined that the change amount t′=t_a_1*x1+t_a_2*x2-t, and the change amount commitment is PC(t′, r′), where r′ is a random number.

It can be seen that, based on the improved account model in the present specification, the revenue balance is dedicated to implementing collection (the revenue balance of the remitter is added to the change amount, and the revenue balance of the remittee is added to the remittance amount), and the asset is dedicated to implementing remittance, so collection and remittance of the same account can be decoupled. Therefore, a user can be involved in both remittance transactions TX1 and TX2 as a remitter of the remittance transaction TX1 and as a remittee of the remittance transaction TX2, thereby implementing concurrent transactions in the account model and improving transaction execution efficiency in the blockchain network.

In addition, when the RP is generated between the above-mentioned remittance amount and the total asset amount, the value of the total asset amount is only related to the selected asset amount commitment and the specified number, and does not involve a total number of each asset amount commitment recorded in the blockchain ledger, so different remittance transactions can separately generate corresponding RPs and do not affect each other. Further, a total number of an asset amount commitment with each value is recorded in a plaintext form in the blockchain ledger, so a blockchain node can directly compare a specified number included in a remittance transaction with a total number recorded in the blockchain ledger. If the specified number is not greater than the total number, the corresponding remittance transaction is allowed to be executed; otherwise, the corresponding remittance transaction is not allowed to be executed. Therefore, one user can simultaneously serve as remitters of multiple remittance transactions, to implement concurrent transactions in the account model, thereby improving transaction execution efficiency in the blockchain network. In addition, when a remittance transaction generated later arrives preferentially at a blockchain node, the blockchain node can preferentially process the later generated remittance transaction without waiting for complete execution of the earlier generated remittance transaction, thereby avoiding transaction congestion at the blockchain node.

As described above, when the account includes the revenue balance and the asset information, input and output decoupling of the account can be implemented while transaction privacy is ensured, thereby implementing high-concurrency transfer under the account model. However, because all funds transferred into the account are recorded in the revenue balance, and all funds transferred out are deducted from the asset information (the value of the total number is decreased), the value of the total number (that is, the asset in the account) is decreasing, and can be smaller than the specified number in the remittance transaction, which affects execution of the remittance transaction. To ensure that the total number is always sufficient to complete the transaction, the total number can be adjusted periodically or at any time by recharging.

Taking a recharging process of the remitter account as an example, the blockchain node can receive a recharging transaction. The recharging transaction includes an asset amount commitment with at least one specified value and a corresponding recharging number, and an RP used to prove that a revenue balance of the remitter account is not less than a recharging amount. The recharging amount is a weighted sum of an asset amount corresponding to the asset amount commitment with the specified value and the recharging number. The blockchain node performs the recharging transaction, so a total number in the remitter account corresponding to the asset amount commitment with the specified value increases by the corresponding recharging number after the transaction is completed, and the revenue balance of the remitter account decreases by a weighted sum of the asset amount commitment with the at least one specified value and the corresponding recharging number after the transaction is completed. In other words, at least one part of the revenue balance in the remitter account can be marked out and converted into corresponding assets. These assets can increase values of total numbers of corresponding asset amount commitments. Certainly, the remittee account can also be recharged in the previous method.

Although the asset recharging operation based on the revenue balance can be implemented in the previous method, when the account participates in frequent remittance transactions and a large amount of remittance, the previous method can cause frequent recharging. As a result, the revenue balance frequently participates in transfer-in and transfer-out (recharging) of funds, and even a transfer-in transaction (remittance transaction from another account to the account) and the recharging transaction affects each other, reducing efficiency. Therefore, the account structure shown in FIG. 4 can be further improved in the present specification to obtain an account structure shown in FIG. 7. Based on the account structure shown in FIG. 4, in addition to the revenue balance and the asset information, account A further includes a primary balance, that is, account A includes three parts in total: the primary balance, the revenue balance, and the asset information. The revenue balance is specially used to receive a transaction amount of a transfer-in transaction, and the asset information is specially used to participate in a transfer-out transaction. The primary balance is used to recharge the asset information, to prevent the revenue balance from performing a recharging task and avoid impact described above.

Taking the remitter as an example, the blockchain node can receive a recharging transaction. The recharging transaction includes an asset amount commitment with at least one specified value and a corresponding recharging number, and an RP used to prove that the primary balance is not less than the recharging amount. The recharging amount is a weighted sum of an asset amount corresponding to the asset amount commitment with the at least one specified value and the corresponding recharging number. The blockchain node performs the recharging transaction, so a total number in the remitter account corresponding to the asset amount commitment with the at least one specified value increases by the corresponding recharging number after the transaction is completed, and the primary balance of the remitter account decreases by a weighted sum of the asset amount commitment with the at least one specified value and the corresponding recharging number after the transaction is completed. For a specific interaction process, reference can be made to the implementation shown in FIG. 8, and FIG. 9 further shows a change situation before and after account recharging. Details are omitted here.

As the asset information in the account is constantly involved in transfer-out transactions, and the primary balance constantly recharges the asset information, the primary balance is gradually reduced. When the primary balance is reduced to a certain degree or 0, recharging cannot continue. Therefore, funds obtained from the revenue balance can be transferred to the primary balance so the account can participate in transfer-out transactions continuously.

Taking the remitter as an example, the blockchain node can receive a merging transaction containing an asset amount commitment with at least one specified value and a corresponding merging number; then, perform the merging transaction, so a total number in the remitter account corresponding to the asset amount commitment with the at least one specified value decreases by a corresponding merging number after the transaction is completed, the primary balance increases by a merging amount commitment after the transaction is completed, and/or the revenue balance of the remitter account is cleared after the transaction is completed, and the primary balance of the remitter account increases by a corresponding revenue balance commitment after the transaction is completed. The merging amount commitment is a weighted sum of the asset amount commitment with the at least one specified value and the corresponding merging number. In other words, the merging transaction can merge all funds contained in the revenue balance into the primary balance, or in some cases, can merge at least a portion of assets into the primary balance in the form of funds, or can merge the funds contained in the revenue balance into the primary balance and merge at least a portion of the assets into the primary balance in the form of funds. For a specific interaction process, reference can be made to the implementation shown in FIG. 10, and FIG. 11 further shows a change situation before and after merging. Details are omitted here.

In the implementations provided in the present specification, for the primary balance, the revenue balance, and the asset information included in the account, the asset information can participate in a transfer-out transaction, the revenue balance can participate in a transfer-in transaction (the revenue balance also collects a change amount in a transfer-out transaction), and the primary balance can participate in a recharging transaction and a merging transaction. This does not mean that each balance can participate only in the previous type of transaction. For example, the account structure of the present specification is also compatible with a primary balance transfer transaction where the primary balance participates in fund transfer-out.

For example, the blockchain node can receive a primary balance remittance transaction. The primary balance remittance transaction includes a primary balance transaction amount commitment corresponding to a primary balance transaction amount between the remitter and the remittee, and an RP used to prove that the primary balance transaction amount is non-negative and not greater than the primary balance. The blockchain node performs the primary balance remittance transaction, so the primary balance transaction amount commitment is deducted from the primary balance after the transaction is completed, and the primary balance transaction amount commitment is added to the revenue balance of the remittee account after the transaction is completed. For a specific interaction process, reference can be made to the implementation shown in FIG. 12, and FIG. 13 further shows a change situation before and after a transaction. Details are omitted here.

FIG. 15 is a schematic structural diagram illustrating a device, according to an example implementation. Referring to FIG. 15, in terms of hardware, the device includes a processor 1502, an internal bus 1504, a network interface 1506, a memory 1508, and a non-volatile memory 1510, and certainly can further include hardware needed by other services. The processor 1502 reads a corresponding computer program from the non-volatile memory 1510 to the memory 1508 and runs the computer program to logically form an apparatus for implementing a confidential transaction in a blockchain network. Certainly, in addition to a software implementation, one or more implementations of the present specification do not exclude other implementations, for example, a logic device or a combination of hardware and software. That is, an execution body of the following processing procedure is not limited to each logical unit, and can also be hardware or a logic device.

Referring to FIG. 16, in a software implementation method, the apparatus for implementing a confidential transaction in a blockchain network is applied to a remitter device (a hardware structure of the remitter device is shown in FIG. 15) and can include: a determining unit 1601, configured to determine a remittance amount between a remitter and a remittee, where the remitter has a corresponding remitter account in a blockchain ledger, the remitter account includes a revenue balance recorded as a revenue balance commitment, an asset whose corresponding asset amount is recorded as an asset amount commitment, and a total number of an asset amount commitment with each value, and assets having the same asset amount have the same asset amount commitment; a remittance transaction creation unit 1602, configured to create a remittance transaction based on a selected asset amount commitment in the remitter account and a specified number corresponding to each selected asset amount commitment, where the remittance transaction includes a remittance amount commitment corresponding to the remittance amount, each selected asset amount commitment and a corresponding specified number, and an RP used to prove that the remittance amount is non-negative and not greater than a total asset amount, and the total asset amount is a weighted sum of an asset amount corresponding to each selected asset amount commitment and the corresponding specified number; and a remittance transaction submission unit 1603, configured to submit the remittance transaction to a blockchain, so the corresponding specified number is subtracted from a total number corresponding to each selected asset amount commitment, the revenue balance of the remitter account is increased by a change amount commitment after the transaction is completed, and a revenue balance of a remittee account corresponding to the remittee in the blockchain ledger is increased by the remittance amount commitment after the transaction is completed.

Optionally, all assets included in the remitter account are corresponding to an asset amount with the same predetermined value; or the remitter account includes multiple asset groups, all assets of each asset group are corresponding to an asset amount with the same predetermined value, and assets of different asset groups are corresponding to asset amounts with different predetermined values.

Optionally, the remitter account further includes a primary balance recorded as a primary balance commitment; and the apparatus further includes: a first recharging transaction creation unit, configured to create a recharging transaction, where the recharging transaction includes an asset amount commitment with at least one specified value and a corresponding recharging number, and an RP used to prove that the primary balance is not less than a recharging amount, and the recharging amount is a weighted sum of an asset amount corresponding to the asset amount commitment with the at least one specified value and the corresponding recharging number; and a first recharging transaction submission unit, configured to submit the recharging transaction to the blockchain, so a total number corresponding to the asset amount commitment with the at least one specified value in the remitter account is increased by the corresponding recharging number after the transaction is completed, and the primary balance of the remitter account is decreased by a weighted sum of the asset amount commitment with the at least one specified value and the corresponding recharging number after the transaction is completed.

Optionally, the apparatus further includes: a merging transaction creation unit, configured to create a merging transaction including an asset amount commitment with at least one specified value and a corresponding merging number; and a merging transaction submission unit, configured to submit the merging transaction to the blockchain, so a statistical amount corresponding to the asset amount commitment with the at least one specified value in the remitter account is decreased by a corresponding merging amount after the transaction is completed, the primary balance is increased by the merging amount commitment after the transaction is completed, and/or the revenue balance of the remitter account is cleared after the transaction is completed, and the primary balance of the remitter account is increased by the corresponding revenue balance commitment after the transaction is completed; and the merging amount commitment is a weighted sum of the asset amount commitment with the at least one specified value and the corresponding merging amount.

Optionally, the apparatus further includes: a primary balance remittance transaction creation unit, configured to generate a primary balance remittance transaction based on a primary balance transaction amount between the remitter and the remittee, where the primary balance remittance transaction includes a primary balance transaction amount commitment corresponding to the primary balance transaction amount, and an RP used to prove that the primary balance transaction amount is non-negative and not greater than the primary balance; and a primary balance remittance transaction submission unit, configured to submit the primary balance remittance transaction to the blockchain, so the primary balance transaction amount commitment is deducted from the primary balance after the transaction is completed, and the revenue balance of the remittee account is increased by the primary balance transaction amount commitment after the transaction is completed.

Optionally, the apparatus further includes: a second recharging transaction creation unit, configured to create a recharging transaction, where the recharging transaction includes an asset amount commitment with at least one specified value and a corresponding recharging number, and an RP used to prove that the revenue balance of the remitter account is not less than a recharging amount, and the recharging amount is a weighted sum of an asset amount corresponding to the asset amount commitment with the specified value and the recharging number; and a second recharging transaction submission unit, configured to submit the recharging transaction to the blockchain, so a total number in the remitter account corresponding to the asset amount commitment with the specified value is increased by the corresponding recharging number after the transaction is completed, and the revenue balance of the remitter account is decreased by a weighted sum of the asset amount commitment with the at least one specified value and the corresponding recharging number after the transaction is completed.

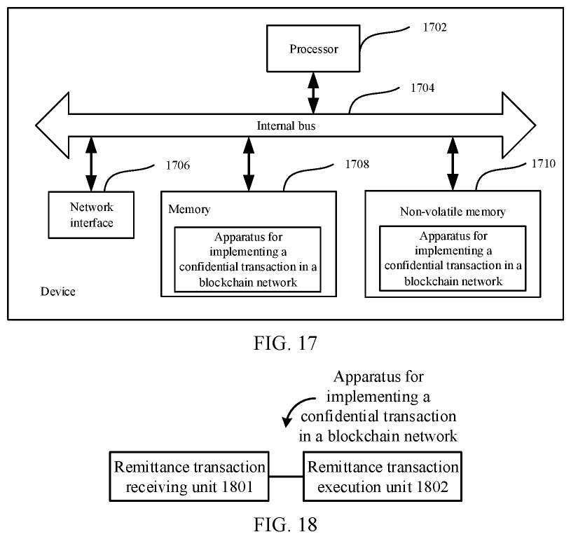

FIG. 17 is a schematic structural diagram illustrating a device, according to an example implementation. Referring to FIG. 17, in terms of hardware, the device includes a processor 1702, an internal bus 1704, a network interface 1706, a memory 1708, and a non-volatile memory 1710, and certainly can further include hardware needed by other services. The processor 1702 reads a corresponding computer program from the non-volatile memory 1710 to the memory 1708 and runs the computer program to logically form an apparatus for implementing a confidential transaction in a blockchain network. Certainly, in addition to a software implementation, one or more implementations of the present specification do not exclude other implementations, for example, a logic device or a combination of hardware and software. That is, an execution body of the following processing procedure is not limited to each logical unit, and can also be hardware or a logic device.

Referring to FIG. 18, in a software implementation method, the apparatus for implementing a confidential transaction in a blockchain network is applied to a blockchain node (a hardware structure of the blockchain node is shown in FIG. 17) and can include: a remittance transaction receiving unit 1801, configured to receive a remittance transaction, where the remittance transaction includes a remittance amount commitment corresponding to a remittance amount between a remitter and a remittee, at least one asset amount commitment and a corresponding specified number, and an RP used to prove that the remittance amount is non-negative and not greater than a total asset amount, where the total asset amount is a weighted sum of an asset amount corresponding to the at least one asset amount commitment and the corresponding specified number, and a remitter account corresponding to the remitter in a blockchain ledger includes a revenue balance recorded as a revenue balance commitment, an asset whose corresponding asset amount is recorded as an asset amount commitment, and a total number of an asset amount commitment with each value, and assets having the same asset amount have the same asset amount commitment; and a remittance transaction execution unit 1802, configured to execute the remittance transaction, so a corresponding specified number is subtracted from a total number corresponding to each asset amount commitment included in the remittance transaction, the revenue balance of the remitter account is increased by a change amount commitment after the transaction is completed, and a revenue balance of a remittee account corresponding to the remittee in the blockchain ledger is increased by the remittance amount commitment after the transaction is completed.

Optionally, all assets included in the remitter account are corresponding to an asset amount with the same predetermined value; or the remitter account includes multiple asset groups, all assets of each asset group are corresponding to an asset amount with the same predetermined value, and assets of different asset groups are corresponding to asset amounts with different predetermined values.

Optionally, the remitter account further includes a primary balance recorded as a primary balance commitment; and the apparatus further includes: a first recharging transaction receiving unit, configured to receive a recharging transaction, where the recharging transaction includes an asset amount commitment with at least one specified value and a corresponding recharging number, and an RP used to prove that the primary balance is not less than a recharging amount, and the recharging amount is a weighted sum of an asset amount corresponding to the asset amount commitment with the at least one specified value and the corresponding recharging number; and a first recharging transaction execution unit, configured to execute the recharging transaction, so a total number in the remitter account corresponding to the asset amount commitment with the at least one specified value is increased by the corresponding recharging number after the transaction is completed, and the primary balance of the remitter account is decreased by a weighted sum of the asset amount commitment with the at least one specified value and the corresponding recharging number after the transaction is completed.

Optionally, the apparatus further includes: a merging transaction receiving unit, configured to receive a merging transaction including an asset amount commitment with at least one specified value and a corresponding merging number; and a merging transaction execution unit, configured to execute the merging transaction, so a total number in the remitter account corresponding to the asset amount commitment with the at least one specified value is decreased by the corresponding merging number after the transaction is completed, the primary balance is increased by a merging amount commitment after the transaction is completed, and/or the revenue balance of the remitter account is cleared after the transaction is completed, and the primary balance of the remitter account is increased by the corresponding revenue balance commitment after the transaction is completed; and the merging amount commitment is a weighted sum of the asset amount commitment with the at least one specified value and the corresponding merging number.

Optionally, the apparatus further includes: a primary balance remittance transaction receiving unit, configured to receive a primary balance remittance transaction, where the primary balance remittance transaction includes a primary balance transaction amount commitment corresponding to a primary balance transaction amount between the remitter and the remittee, and an RP used to prove that the primary balance transaction amount is non-negative and not greater than the primary balance; and a primary balance remittance transaction execution unit, configured to execute the primary balance remittance transaction, so the primary balance transaction amount commitment is deducted from the primary balance after the transaction is completed, and the revenue balance of the remittee account is increased by the primary balance transaction amount commitment after the transaction is completed.

Optionally, the apparatus further includes: a second recharging transaction receiving unit, configured to receive a recharging transaction, where the recharging transaction includes an asset amount commitment with at least one specified value and a corresponding recharging number, and an RP used to prove that the revenue balance of the remitter account is not less than a recharging amount, and the recharging amount is a weighted sum of an asset amount corresponding to the asset amount commitment with the specified value and the recharging number; and a second recharging transaction execution unit, configured to execute the recharging transaction, so a total number in the remitter account corresponding to the asset amount commitment with the specified value is increased by the corresponding recharging number after the transaction is completed, and the revenue balance of the remitter account is decreased by a weighted sum of the asset amount commitment with the at least one specified value and the corresponding recharging number after the transaction is completed.

The system, apparatus, module, or unit illustrated in the previous implementations can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In a typical configuration, the computer includes one or more processors (CPU), an input/output interface, a network interface, and a memory.

The memory can include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on grapheme, another magnetic storage device, or any other non-transmission medium. The computer storage medium can be used to store information that can be accessed by the computing device. Based on the definition in the present specification, the computer readable medium does not include transitory computer readable media (transitory media) such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a ... ” does not preclude the existence of additional identical elements in the process, method, product or device that includes the element.

Specific implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or can be advantageous.

Terms used in one or more implementations of the present specification are merely used to describe specific implementations, and are not intended to limit the one or more implementations of the present specification. The terms “a” and “the” of singular forms used in one or more implementations of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. can be used in one or more implementations of the present specification to describe various types of information, the information is not limited to these terms. These terms are only used to differentiate between information of the same type. For example, without departing from the scope of one or more implementations of the present specification, first information can also be referred to as second information, and similarly, the second information can be referred to as the first information. Depending on the context, for example, the word “if” used here can be explained as “while”, “when”, or “in response to determining”.

The previous descriptions are only example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

1. A computer-implemented method for implementing a transaction in a blockchain network, wherein the method comprises:
determining a remittance amount between a remitter and a remittee, wherein the remitter has a corresponding remitter account in a blockchain ledger, the remitter account comprises a revenue balance recorded as a revenue balance commitment, an asset whose corresponding asset amount is recorded as an asset amount commitment, and a total number of an asset amount commitment with each value, and assets having a same asset amount have a same asset amount commitment;
creating a remittance transaction based on a selected asset amount commitment in the remitter account and a specified number corresponding to each selected asset amount commitment, wherein the remittance transaction comprises a remittance amount commitment corresponding to the remittance amount, each selected asset amount commitment and a corresponding specified number, and a range proof (RP) used to prove that the remittance amount is non-negative and not greater than a total asset amount, and the total asset amount is a weighted sum of an asset amount corresponding to each selected asset amount commitment and the corresponding specified number; and
submitting the remittance transaction to the blockchain network, thereby causing the blockchain network, or programs monitoring the blockchain network, to perform operations comprising: subtracting the corresponding specified number from a total number corresponding to each selected asset amount commitment, increasing the revenue balance of the remitter account by a change amount commitment after the transaction is completed, and increasing a revenue balance of a remittee account corresponding to the remittee in the blockchain ledger by the remittance amount commitment after the transaction is completed.

2. The computer-implemented method according to claim 1, wherein
all assets comprised in the remitter account correspond to an asset amount with a shared value; or
the remitter account comprises multiple asset groups, wherein assets of each asset group correspond to an asset amount with a same predetermined value, and assets of different asset groups correspond to asset amounts with different predetermined values.

3. The computer-implemented method according to claim 1, wherein the remitter account further comprises a primary balance recorded as a primary balance commitment, and the method further comprises:
creating a recharging transaction, wherein the recharging transaction comprises an asset amount commitment with at least one specified value and a corresponding recharging number, and an RP used to prove that the primary balance is not less than a recharging amount, wherein the recharging amount is a weighted sum of an asset amount corresponding to the asset amount commitment with the at least one specified value and the corresponding recharging number; and
submitting the recharging transaction to the blockchain network, thereby causing the blockchain network, or programs monitoring the blockchain network, to perform operations comprising: increasing a total number corresponding to the asset amount commitment with the at least one specified value in the remitter account by the corresponding recharging number after the transaction is completed and decreasing the primary balance of the remitter account by a weighted sum of the asset amount commitment with the at least one specified value and the corresponding recharging number after the transaction is completed.

4. The computer-implemented method of claim 3, further comprising:
creating a merging transaction comprising an asset amount commitment with at least one specified value and a corresponding merging number; and
submitting the merging transaction to the blockchain network, thereby causing the blockchain network, or programs monitoring the blockchain network, to perform operations comprising: decreasing a total number in the remitter account corresponding to the asset amount commitment with the at least one specified value by the corresponding merging number after the transaction is completed, increasing the primary balance by a merging amount commitment after the transaction is completed or the revenue balance of the remitter account is cleared after the transaction is completed, and increasing the primary balance of the remitter account by a corresponding revenue balance commitment after the transaction is completed; and the merging amount commitment is a weighted sum of the asset amount commitment with the at least one specified value and the corresponding merging number.

5. The computer-implemented method of claim 3, further comprising:
generating a primary balance remittance transaction based on a primary balance transaction amount between the remitter and the remittee, wherein the primary balance remittance transaction comprises a primary balance transaction amount commitment corresponding to the primary balance transaction amount, and an RP used to prove that the primary balance transaction amount is non-negative and not greater than the primary balance; and
submitting the primary balance remittance transaction to the blockchain network, thereby causing the blockchain network, or programs monitoring the blockchain network, to perform operations comprising: deducting the primary balance transaction amount commitment from the primary balance after the transaction is completed and increasing the revenue balance of the remittee account by the primary balance transaction amount commitment after the transaction is completed.

6. The computer-implemented method of claim 1, further comprising:
creating a recharging transaction, wherein the recharging transaction comprises an asset amount commitment with at least one specified value and a corresponding recharging number, and an RP used to prove that the revenue balance of the remitter account is not less than a recharging amount, wherein the recharging amount is a weighted sum of an asset amount corresponding to the asset amount commitment with the specified value and the recharging number; and
submitting the recharging transaction to the blockchain network, thereby causing the blockchain network, or programs monitoring the blockchain network, to perform operations comprising: increasing a total number in the remitter account corresponding to the asset amount commitment with the specified value by the corresponding recharging number after the transaction is completed and decreasing the revenue balance of the remitter account by a weighted sum of the asset amount commitment with the at least one specified value and the corresponding recharging number after the transaction is completed.

7. The computer-implemented method of claim 1, wherein at least two transactions are performed in the blockchain network, wherein the two transactions comprise:
a first transaction, wherein a given party is a remitter and has a corresponding remitter account;
a second transaction, wherein the given party is a remittee and has a corresponding remittee account;
and, wherein the first transaction and the second transaction are performed concurrently in the blockchain network.

8. A non-transitory, computer-readable medium storing one or more instructions executable by a computer system to perform operations for implementing a transaction in a blockchain network, wherein the operations comprise:
determining a remittance amount between a remitter and a remittee, wherein the remitter has a corresponding remitter account in a blockchain ledger, the remitter account comprises a revenue balance recorded as a revenue balance commitment, an asset whose corresponding asset amount is recorded as an asset amount commitment, and a total number of an asset amount commitment with each value, and assets having a same asset amount have a same asset amount commitment;
creating a remittance transaction based on a selected asset amount commitment in the remitter account and a specified number corresponding to each selected asset amount commitment, wherein the remittance transaction comprises a remittance amount commitment corresponding to the remittance amount, each selected asset amount commitment and a corresponding specified number, and a range proof (RP) used to prove that the remittance amount is non-negative and not greater than a total asset amount, and the total asset amount is a weighted sum of an asset amount corresponding to each selected asset amount commitment and the corresponding specified number; and
submitting the remittance transaction to the blockchain network, thereby causing the blockchain network, or programs monitoring the blockchain network, to perform operations comprising: subtracting the corresponding specified number from a total number corresponding to each selected asset amount commitment, increasing the revenue balance of the remitter account by a change amount commitment after the transaction is completed, and increasing a revenue balance of a remittee account corresponding to the remittee in the blockchain ledger by the remittance amount commitment after the transaction is completed.

9. The non-transitory, computer-readable medium of claim 8, wherein
all assets comprised in the remitter account correspond to an asset amount with a shared value; or
the remitter account comprises multiple asset groups, wherein assets of each asset group correspond to an asset amount with a same predetermined value, and assets of different asset groups correspond to asset amounts with different predetermined values.

10. The non-transitory, computer-readable medium of claim 8, wherein the remitter account further comprises a primary balance recorded as a primary balance commitment, further comprising:
creating a recharging transaction, wherein the recharging transaction comprises an asset amount commitment with at least one specified value and a corresponding recharging number, and an RP used to prove that the primary balance is not less than a recharging amount, wherein the recharging amount is a weighted sum of an asset amount corresponding to the asset amount commitment with the at least one specified value and the corresponding recharging number; and
submitting the recharging transaction to the blockchain network, thereby causing the blockchain network, or programs monitoring the blockchain network, to perform operations comprising: increasing a total number corresponding to the asset amount commitment with the at least one specified value in the remitter account by the corresponding recharging number after the transaction is completed and decreasing the primary balance of the remitter account by a weighted sum of the asset amount commitment with the at least one specified value and the corresponding recharging number after the transaction is completed.

11. The non-transitory, computer-readable medium of claim 10, further comprising:
creating a merging transaction comprising an asset amount commitment with at least one specified value and a corresponding merging number; and
submitting the merging transaction to the blockchain network, thereby causing the blockchain network, or programs monitoring the blockchain network, to perform operations comprising: decreasing a total number in the remitter account corresponding to the asset amount commitment with the at least one specified value by the corresponding merging number after the transaction is completed, increasing the primary balance by a merging amount commitment after the transaction is completed or the revenue balance of the remitter account is cleared after the transaction is completed, and increasing the primary balance of the remitter account by a corresponding revenue balance commitment after the transaction is completed; and the merging amount commitment is a weighted sum of the asset amount commitment with the at least one specified value and the corresponding merging number.

12. The non-transitory, computer-readable medium of claim 10, further comprising:
generating a primary balance remittance transaction based on a primary balance transaction amount between the remitter and the remittee, wherein the primary balance remittance transaction comprises a primary balance transaction amount commitment corresponding to the primary balance transaction amount, and an RP used to prove that the primary balance transaction amount is non-negative and not greater than the primary balance; and
submitting the primary balance remittance transaction to the blockchain network, thereby causing the blockchain network, or programs monitoring the blockchain network, to perform operations comprising: deducting the primary balance transaction amount commitment from the primary balance after the transaction is completed and increasing the revenue balance of the remittee account by the primary balance transaction amount commitment after the transaction is completed.

13. The non-transitory, computer-readable medium of claim 8, further comprising:
creating a recharging transaction, wherein the recharging transaction comprises an asset amount commitment with at least one specified value and a corresponding recharging number, and an RP used to prove that the revenue balance of the remitter account is not less than a recharging amount, wherein the recharging amount is a weighted sum of an asset amount corresponding to the asset amount commitment with the specified value and the recharging number; and
submitting the recharging transaction to the blockchain network, thereby causing the blockchain network, or programs monitoring the blockchain network, to perform operations comprising: increasing a total number in the remitter account corresponding to the asset amount commitment with the specified value by the corresponding recharging number after the transaction is completed and decreasing the revenue balance of the remitter account by a weighted sum of the asset amount commitment with the at least one specified value and the corresponding recharging number after the transaction is completed.

14. The non-transitory, computer-readable medium of claim 8, wherein at least two transactions are performed in the blockchain network, wherein the two transactions comprise:
a first transaction, wherein a given party is a remitter and has a corresponding remitter account;
a second transaction, wherein the given party is a remittee and has a corresponding remittee account;
and, wherein the first transaction and the second transaction are performed concurrently in the blockchain network.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for implementing a transaction in a blockchain network, wherein the operations comprise:
determining a remittance amount between a remitter and a remittee, wherein the remitter has a corresponding remitter account in a blockchain ledger, the remitter account comprises a revenue balance recorded as a revenue balance commitment, an asset whose corresponding asset amount is recorded as an asset amount commitment, and a total number of an asset amount commitment with each value, and assets having a same asset amount have a same asset amount commitment;
creating a remittance transaction based on a selected asset amount commitment in the remitter account and a specified number corresponding to each selected asset amount commitment, wherein the remittance transaction comprises a remittance amount commitment corresponding to the remittance amount, each selected asset amount commitment and a corresponding specified number, and a range proof (RP) used to prove that the remittance amount is non-negative and not greater than a total asset amount, and the total asset amount is a weighted sum of an asset amount corresponding to each selected asset amount commitment and the corresponding specified number; and
submitting the remittance transaction to the blockchain network, thereby causing the blockchain network, or programs monitoring the blockchain network, to perform operations comprising: subtracting the corresponding specified number from a total number corresponding to each selected asset amount commitment, increasing the revenue balance of the remitter account by a change amount commitment after the transaction is completed, and increasing a revenue balance of a remittee account corresponding to the remittee in the blockchain ledger by the remittance amount commitment after the transaction is completed.

16. The computer-implemented system of claim 15, wherein
all assets comprised in the remitter account correspond to an asset amount with a shared value; or
the remitter account comprises multiple asset groups, wherein assets of each asset group correspond to an asset amount with a same predetermined value, and assets of different asset groups correspond to asset amounts with different predetermined values.

17. The computer-implemented system of claim 15, wherein the remitter account further comprises a primary balance recorded as a primary balance commitment, further comprising:
creating a recharging transaction, wherein the recharging transaction comprises an asset amount commitment with at least one specified value and a corresponding recharging number, and an RP used to prove that the primary balance is not less than a recharging amount, wherein the recharging amount is a weighted sum of an asset amount corresponding to the asset amount commitment with the at least one specified value and the corresponding recharging number; and
submitting the recharging transaction to the blockchain network, thereby causing the blockchain network, or programs monitoring the blockchain network, to perform operations comprising: increasing a total number corresponding to the asset amount commitment with the at least one specified value in the remitter account by the corresponding recharging number after the transaction is completed and decreasing the primary balance of the remitter account by a weighted sum of the asset amount commitment with the at least one specified value and the corresponding recharging number after the transaction is completed.

18. The computer-implemented system of claim 17, further comprising:
creating a merging transaction comprising an asset amount commitment with at least one specified value and a corresponding merging number; and
submitting the merging transaction to the blockchain network, thereby causing the blockchain network, or programs monitoring the blockchain network, to perform operations comprising: decreasing a total number in the remitter account corresponding to the asset amount commitment with the at least one specified value by the corresponding merging number after the transaction is completed, increasing the primary balance by a merging amount commitment after the transaction is completed or the revenue balance of the remitter account is cleared after the transaction is completed, and increasing the primary balance of the remitter account by a corresponding revenue balance commitment after the transaction is completed; and the merging amount commitment is a weighted sum of the asset amount commitment with the at least one specified value and the corresponding merging number.

19. The computer-implemented system of claim 15, further comprising:
creating a recharging transaction, wherein the recharging transaction comprises an asset amount commitment with at least one specified value and a corresponding recharging number, and an RP used to prove that the revenue balance of the remitter account is not less than a recharging amount, wherein the recharging amount is a weighted sum of an asset amount corresponding to the asset amount commitment with the specified value and the recharging number; and
submitting the recharging transaction to the blockchain network, thereby causing the blockchain network, or programs monitoring the blockchain network, to perform operations comprising: increasing a total number in the remitter account corresponding to the asset amount commitment with the specified value by the corresponding recharging number after the transaction is completed and decreasing the revenue balance of the remitter account by a weighted sum of the asset amount commitment with the at least one specified value and the corresponding recharging number after the transaction is completed.

20. The computer-implemented system of claim 15, wherein at least two transactions are performed in the blockchain network, wherein the two transactions comprise:
a first transaction, wherein a given party is a remitter and has a corresponding remitter account;
a second transaction, wherein the given party is a remittee and has a corresponding remittee account;
and, wherein the first transaction and the second transaction are performed concurrently in the blockchain network.
